(19) United States
(12) Patent Application Publication
(10) Pub. No.: US 2025/0245985 A1
(43) Pub. Date: Jul. 31, 2025

(54) VISUAL DETECTION OF CROP ROWS

(71) Applicant: Ag Leader Technology, Inc., Ames, IA (US)

(72) Inventors: Josue Calderon, Apex, NC (US); Trent Anagnostopoulos, Ankeny, IA (US); Scott Eichhorn, Ames, IA (US); Ali Haider, Ames, IA (US)

(73) Assignee: Ag Leader Technology, Inc., Ames, IA (US)

(21) Appl. No.: 19/041,825

(22) Filed: Jan. 30, 2025

Related U.S. Application Data
(60) Provisional application No. 63/571,901, filed on Mar. 29, 2024.
(60) Provisional application No. 63/571,913, filed on Mar. 29, 2024.
(60) Provisional application No. 63/565,926, filed on Mar. 15, 2024.
(60) Provisional application No. 63/627,522, filed on Jan. 31, 2024.

(51) Int. Cl. G06V 20/10; A01B 69/04; G06T 7/13; G06T 7/73; G06V 20/56

(52) U.S. Cl. CPC G06V 20/188; A01B 69/008; G06T 7/13; G06T 7/73; G06V 20/56; G06T 2207/20021; G06T 2207/30188; G06T 2207/30248

(57) ABSTRACT

A method for visually identifying crop rows includes acquiring imagery from at least one imaging device operatively connected to an agricultural vehicle while the agricultural vehicle is traversing a field, the imagery includes plants arranged in rows, processing the imagery at a computing device to preserve spatial information along a first dimension while reducing data complexity along a second dimension to generate processed data, analyzing the processed data to identify locations of the rows within the field. The method may include dividing the imagery into multiple sections along a direction of travel of the agricultural vehicle and for each section, performing statistical analysis to generate a one-dimensional intensity profile, applying an edge detection operation to identify predominantly vertical features within the imagery and filtering out predominantly horizontal features to isolate plant stalks, and/or identifying spatial relationships between neighboring rows and using the spatial relationships to validate row identification.

### RELATED APPLICATIONS

This application claims priority to: U.S. Provisional Patent Application No. 63/571,901, filed Mar. 29, 2024, entitled CENTER OF PLANT FINDER; U.S. Provisional Patent Application No. 63/571,913, filed Mar. 29, 2024, entitled REGRESSION ON VISUAL PLANTS; U.S. Provisional Patent Application No. 63/565,926, filed Mar. 15, 2024, entitled NEIGHBORING ROWS; U.S. Provisional Patent Application No. 63/627,522, filed Jan. 31, 2024, entitled COLUMN BASED IDENTIFICATION OF CROP ROWS; all of which are incorporated by reference in their entireties.

### FIELD OF THE INVENTION

The present disclosure relates to machine vision. More specifically, but not exclusively, the present invention relates to identifying rows such as crop rows using machine vision.

### BACKGROUND

Although the background is generally focused on the identification of plants and/or crop rows within an agricultural field and related problems, it is to be understood that different features of this disclosure may be used in other applications or environments. Therefore, the background discussion is not to be considered limiting. In addition, the background discusses numerous problems associated with the identification of plants and/or crop rows within an agricultural field and it is to be understood that one skilled in the art would not necessarily recognize all of these problems or the inter-relationships between these problems without having the benefit of this disclosure.

Machine vision systems have become increasingly important in agricultural applications, particularly for identifying crop rows to enable automated guidance and agronomic analysis. While various methods have been developed for machine vision applications like road lane detection, adapting these methods to agricultural settings presents unique challenges and limitations.

Agricultural environments differ fundamentally from controlled settings like roads or industrial applications. The placement and mounting of cameras on agricultural equipment presents distinct challenges not typically encountered elsewhere. Equipment configurations change when different implements attach to tractors or boom positions adjust on sprayers, requiring vision systems that maintain accuracy across varying mounting positions and heights rather than relying on carefully controlled camera placement.

These conventional approaches often share fundamental limitations. They rely on identifying features directly within two-dimensional image space and typically assume relatively straight lines, making them poorly suited for curved rows. Agricultural row curvature often exceeds what conventional methods can handle, unlike gradual road curves. They struggle with varying plant sizes, inconsistent lighting, missing plants, and weed pressure between rows. The challenge intensifies as crops mature and develop overlapping canopy, making it difficult to distinguish individual plants and row boundaries.

Specific challenges further degrade row estimation quality. Crop rows may disappear mid-field due to mechanical failures, insect pressure, or being run over. Weeds can obscure rows by filling spaces between them with similarly-sized green plants. Water management issues may create curved washouts requiring detection of distant rows for continued guidance. Row width varies significantly-common spacings include 30, 21, or 15 inches, while tramlines may have custom widths. As plants grow, spaces between rows decrease irregularly due to random leaf orientation. Current solutions only work in limited growth stages with adequate spacing and often require manual row width selection.

Previous attempts to address these limitations focused on post-processing steps or complex filtering algorithms. While such solutions increased computational overhead, they provided only incremental improvements without addressing the fundamental problem of maintaining spatial relationships while handling agricultural imagery's inherent variability.

Another challenge involves efficient storage of detected features. While existing tools like OpenCV allow iteration over detected edges, they lack efficient ways to store macro features or handle broken features like crop rows split into individual plants. Current methods cannot efficiently store features when semantic segmentation divides what should be single items.

What is needed are improved methods that: naturally handle curved rows while maintaining accuracy across varying field conditions; maintain essential spatial relationships while reducing analysis complexity; work throughout the growing season; operate efficiently in real-time; better estimate inter-row spacing; automatically determine planted width; and store detected features efficiently. These methods should work without assuming straight lines or ideal conditions and should handle the full range of real-world agricultural challenges.

### SUMMARY

Therefore, it is a primary object, feature, or advantage of this disclosure to improve over the state of the art.

It is a further object, feature, or advantage to provide a row finding methodology for use in agricultural environments that works in sharp curves without sacrificing accuracy.

It is a still further object, feature, or advantage to provide a row finding methodology which may be performed in real-time and onboard an agricultural vehicle.

Another object, feature, or advantage is to provide a row finding methodology which may be used to generate and/or follow guidance lines within a field so as to avoid crop damage.

Yet another object, feature, or advantage is to identify crop rows within a field in order to enable agronomic evaluations and analysis related to the crop.

A further object, feature, or advantage is to provide a row finding methodology with application in areas outside of agricultural vehicles. One or more of these and/or other objects, features, or advantages will become apparent from the description that follows. No single embodiment need provide each and every object, feature, or advantage as different embodiments may have different objects, features, or advantages.

Therefore, it is a primary object feature, or advantage of the present disclosure to improve over the state of the art.

It is a further object, feature, or advantage of the present disclosure to provide for visual detection of crop rows where multiple rows are present.

Another object, feature, or advantage is to provide visual steering for an agricultural machine.

It is a still further object, feature, or advantage of the present disclosure to provide for row detection even where a large number of weeds are obscuring the row.

Another object, feature, or advantage is to provide for row detection despite disappearing portions of a row due to being run over, planter mechanical failure, or insect pressure.

Another object, feature, or advantage is to provide for row detection despite water management issues such as washouts.

Yet another object, feature, or advantage is to provide for visual detection of crops which expands the suitable growth stage relative to prior art approaches.

A further object, feature, or advantage is a method for visual detection of crop rows which does not require an individual to select the crop row width.

A still further object, feature, or advantage is a method for visual detection of crop rows which may be used for both straight rows and curved rows without user interaction.

Another object, feature, or advantage is a method for improving robustness of visually detected rows of crops in tough environments such as weedy or grassy fields, large amounts of volunteer plants, and varying row widths for a wide variety of row crop types.

Yet another object, feature, or advantage is to improve upon existing techniques by combining all rows within view to better estimate the empty spaces available for the vehicle's wheels and by automatically adjusting the expected distance between rows.

A still further object, feature, or advantage is to combine knowledge from multiple rows to help filter out volunteer plants, weeds, washouts, and missing rows.

Another object, feature, or advantage is to adjust the row width dynamically to allow a follow vehicle to continue operation between different planting widths without user interaction.

Yet another object, feature, or advantage is to identify rows in later stage plants that cover more of the open space between rows. Finally, this method works for both straight rows and curved rows without user interaction.

It is a further object, feature, or advantage of the present invention to identify features or series of features in an image in order to reduce data storage.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by any objects, features, or advantages stated herein.

According to one aspect, a method for identifying crop rows in real-time or post-processing include steps of acquiring an image from at least one camera associated with an agricultural vehicle while the agricultural vehicle is within a crop field, the image including a portion of at least one crop row, converting the image into 2-dimensional space to provide a 2-dimensional image and trimming one of the image or the 2-dimensional image to a subset of the image associated with a region of interest within the image, slicing the subset of the image associated with the region of interest into at least one section, statistically analyzing each of the at least one section to provide a single dimensional summary for each of the least one section, and processing the single dimensional summary for each of the at least one section to identify features (such as peaks or troughs) as crop row centers for each of the at least one sections. The image may be a color image, a 2-dimensional depth image, a thermal image, a time-of-flight image, or other type of image. The method may further include generating a guidance line between crop rows using the crop row centers. The method may further include generating steering commands to steer the agricultural vehicle along the guidance line and/or steering the agricultural vehicle along the guidance line. At least one camera may be mounted on an agricultural vehicle. The method may further include applying a perspective warp to the region of interest. The image may be a color image and converting the color image into 2-dimensional space may be performed by converting the color image to gray-scale. The image may be a color image and converting the color image into 2-dimensional space may be performed by converting the image to one of an HSL format and a HSV format and then retaining only the hue channel. The processing of the single dimensional summary for each of the at least one section to identify the peaks as the crop row centers may be performed by applying a gradient descent algorithm. The processing of the single dimensional summary for each of the at least one section to identify the peaks as the crop row centers may be performed by identifying the peaks using peak prominence. The method may further include performing an analysis using the peaks and wherein the analysis is selected from a set consisting of an emergence analysis, a stand-count analysis, a crop health analysis, a weed pressure analysis, a pest pressure analysis, and a fertilizer effect analysis. The method may further include performing an agronomic evaluation associated with the crop using the peaks. The trimming may be of the image and may be performed prior to converting the image into 2-dimensional space. The trimming may be of the 2-dimensional image and the converting the image into 2-dimensional space may occur prior to the trimming. The steps may be performed onboard the agricultural vehicle while the agricultural vehicle is traveling within the crop field.

According to another aspect, a method for identifying rows in real-time includes steps of acquiring a color image from at least one camera, the color image including a portion of at least one row, converting the color image into 2-dimensional space to provide a 2-dimensional image and trimming one of the color image or the 2-dimensional image to a subset of the color image associated with a region of interest within the color image, horizontally slicing the subset of the color image associated with the region of interest into at least one section, statistically analyzing each of the at least one section to provide a single dimensional summary for each of the least one section, and processing the single dimensional summary for each of the at least one section to identify peaks as row centers for each of the at least one sections. Each of the rows may be a crop row within a field and the steps may be performed onboard an agricultural vehicle, with at least one camera mounted to the agricultural vehicle.

According to another aspect, a system for identifying crop rows in real-time is provided. The system includes at least one camera and one or more processors configured to: acquire an image from the at least one camera associated with an agricultural vehicle while the agricultural vehicle is within a crop field, the image including a portion of at least one crop row, convert the image into 2-dimensional space to provide a 2-dimensional image and trimming one of the image or the 2-dimensional image to a subset of the image associated with a region of interest within the image, horizontally slice the subset of the image associated with the region of interest into at least one section, statistically analyze each of the at least one section to provide a single dimensional summary for each of the least one section, and process the single dimensional summary for each of the at least one section to identify peaks as crop row centers for each of the at least one sections.

According to another aspect a method is provided for improving robustness of visually detected rows of crops in tough environments such as weedy or grassy fields, large amounts of volunteer plants, and varying row widths for a wide variety of row crop types.

According to one aspect, a method for visual detection of crop rows is provided. The method includes acquiring imagery from a camera operatively connected to an agricultural machine, the imagery including a plurality of rows associated with a path, and at a processor, estimating the path based on the plurality of rows within the imagery by combining information from each of the plurality of rows. The step of estimating the path based on the plurality of rows within the imagery may include a step of projecting locations of a subset of the plurality of rows onto another one of the plurality of rows. The step of estimating the path based on the plurality of rows within the imagery may include projecting locations of open spaces between neighboring ones of the plurality of rows onto another one of the open spaces. The method may further include generating a guidance line for steering a vehicle based on the path. The row width may be associated with each of the plurality of rows. The method may further include estimating row width dynamically by comparing distance between multiple rows in real time and estimating a singular true row spacing by error reduction. The method may further include fitting a curve or line to each of the plurality of rows and statistically determining a fit for the plurality of rows. The step of statistically determining the fit may include averaging fit from the curve or line for each of the plurality of rows. The step of estimating the path based on the plurality of rows within the imagery by combining information from each of the plurality of rows may be performed using a machine learning model such as a neural net which was trained with previously acquired data from methods described herein. The method may also include identifying plants which are misaligned with the rows, marking the plants misaligned with the rows, and characterizing the plants misaligned with the rows such as weeds or volunteer plants or otherwise.

According to another aspect of the present disclosure, a method of estimating row width dynamically is provided. The method includes acquiring imagery comprising multiple crop rows within a field, at a computing device, determining distance between the multiple crop rows and comparing the distance between the multiple crop rows in real-time, and estimating at the computing device a singular true crop row spacing for the multiple crop rows using error reduction. The method may further include applying a multiple center algorithm to mark or annotate space between rows and train a neural net using results from the multiple center algorithm to identify space between rows as training data.

According to another aspect, a method for visually identifying crop rows may include acquiring imagery from at least one imaging device operatively connected to an agricultural vehicle while the agricultural vehicle traverses a field, wherein the imagery includes a plurality of plants arranged in rows. The imagery may be processed at a computing device to preserve spatial information along a first dimension while reducing data complexity along a second dimension to generate processed data. Processing the imagery may include dividing the imagery into multiple sections along a direction of travel of the agricultural vehicle and performing statistical analysis for each section to generate a one-dimensional intensity profile. Additionally, processing may include applying an edge detection operation to identify predominantly vertical features within the imagery and filtering out predominantly horizontal features to isolate plant stalks. The processed data may be analyzed to identify locations of the rows within the field, wherein analyzing may include identifying peaks within the processed data that correspond to centers of the rows.

Spatial relationships between neighboring rows may be identified and used to validate row identification, and row spacing may be dynamically determined based on these spatial relationships. A mathematical representation of the identified rows may be generated using continuous functions and used to interpolate row locations between identified points. Where the imagery includes a region of interest ahead of the agricultural vehicle, steering commands may be generated based on the identified row locations within this region. Plants deviating from the identified row locations may be identified and characterized as either weeds or volunteer plants. The computing device may be onboard the agricultural vehicle. A guidance line, which may be curved, may be generated based on the locations of the rows within the field, and steering commands for the agricultural vehicle may be generated based on this guidance line.

According to another aspect, a system for identifying crop rows in real-time is provided. The system includes at least one camera associated with an agricultural vehicle, one or more processors configured to: acquire an image from the at least one camera associated with the agricultural vehicle while the agricultural vehicle is within a crop field, the image including a portion of at least one crop row; process the image to preserve spatial information along a first dimension while reducing data complexity along a second dimension to generate processed data; and analyze the processed data to identify locations of the at least one crop row. The system may further include a location determination receiver operatively connected to the one or more processors to provide a location of the agricultural vehicle. The one or more processors may be further configured to analyze the processed data by identifying peaks within the processed data, wherein the peaks correspond to centers of the rows. The one or more processors may be further configured to identify spatial relationships between neighboring rows, and use the spatial relationships to validate row identification. The one or more processors may be further configured to dynamically determine row spacing based on the spatial relationships between neighboring rows. The one or more processors may be further configured to generate a mathematical representation of the identified rows using continuous functions and to use the mathematical representation to interpolate row locations between identified points.

According to another aspect, a method for visually identifying crop rows includes acquiring imagery from at least one imaging device operatively connected to an agricultural vehicle while the agricultural vehicle traverses a field, wherein the imagery includes plants arranged in rows. The imagery may be processed at a computing device to preserve spatial information along a first dimension while reducing data complexity along a second dimension to generate processed data by dividing the imagery into multiple sections along a direction of travel and performing statistical analysis for each section. The processed data may be analyzed to identify locations of the rows within the field by identifying peaks corresponding to centers of the rows and validating identified peaks using spatial relationships between neighboring rows. The method may include converting the imagery to 2-dimensional space, trimming to a region of interest, applying perspective warps, generating guidance lines, and performing agronomic analyses.

According to another aspect, a method for identifying crop features in an agricultural setting includes receiving image data from an image capture device mounted to an agricultural vehicle, identifying regions having predominantly vertical orientation through edge detection, filtering out regions having predominantly horizontal orientation to create a filtered image emphasizing vertical plant features, analyzing the filtered image to identify crop stalk locations, and generating guidance commands based on the identified locations. The method may include perspective transforms, column-wise intensity profiling, detection of lodged conditions, multi-camera refinement, and crop health mapping based on vertical feature ratios.

According to another aspect, a method for visual detection of crop rows includes acquiring imagery from a camera operatively connected to an agricultural machine, performing perspective transforms to linearize the image, identifying plant positions, locating centers between neighboring rows through geometric center calculations, and estimating row width dynamically through determination of distances between centers and error reduction techniques. The method may include iterative center analysis, identification of misaligned plants, characterization of weeds or volunteer plants, and generation of guidance lines based on projected centers.

According to another aspect, a method for reducing storage space requirements for imagery includes acquiring an image using an image capture device mounted to an agricultural vehicle, identifying features representing crop rows, describing the features through continuous mathematical functions, and storing coefficients instead of pixels to reduce storage requirements. The method may include various mathematical function types, multiple point fitting, interpolation for missing plants, and application of physical constraint filtering.

According to another aspect, a method for estimating row width dynamically includes acquiring imagery comprising multiple crop rows, identifying centers between adjacent rows, determining distances between rows, comparing distances in real-time, and estimating true crop row spacing through error reduction and historical filtering. The method may include iterative error minimization, neural network training for space identification, and dynamic guidance line generation based on updated spacing calculations.

According to another aspect, a system for identifying crop rows in real-time includes at least one camera associated with an agricultural vehicle, memory storing instructions, and processors configured to acquire imagery, process the imagery while preserving spatial information, identify row locations, determine spatial relationships, estimate row spacing, and generate guidance commands for vehicle control.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Illustrated aspects of the disclosure are described in detail below with reference to the attached drawing figures, which are incorporated by reference herein.

FIG. 1 is an overview of a methodology which includes acquiring crop imagery, locating plants, and/or identifying rows, storing the rows, and performing an analysis or generating guidance lines.

FIG. 2 illustrates one example of a system which may be used in performing various methodologies.

FIG. 3 is a flow chart of methodology for visually identifying crop rows.

FIG. 4 is a flow diagram illustrating a more detailed example of the methodology where column-based identification of row crops is used.

FIG. 5 is a flow chart which illustrates two alternate methods for processing a subsection of a 3D color image into 2D space.

FIG. 6 is an image from a front facing camera mounted on an agricultural vehicle.

FIG. 7 illustrates a region of interest highlighted.

FIG. 8 further illustrates the two alternate methods for processing a subsection of a 3D color image into 2D space using photos.

FIG. 9 illustrates horizontal slicing of a 2D image.

FIG. 10 illustrates compressing each slice.

FIG. 11 illustrates compressed data from a single slice (top), the same data but plotted in 1D space (middle), and data after filtering with the peaks highlighted (bottom).

FIG. 12 is a region of interest shown with the centers of the rows highlighted.

FIG. 13 is an image of crop rows planted along a curve.

FIG. 14 illustrates ROI for crop rows curving to the right with centers of the rows highlighted.

FIG. 15 illustrates the central guidance line drawn between two crop rows with the region of interest shown for each camera.

FIG. 16 illustrates an agricultural vehicle in the form of a sprayer with a camera with a front-facing view of crops.

FIG. 17 illustrates an array of 3 cameras mounted on a sprayer where each camera may see 4 rows of crops.

FIG. 18 illustrates a block diagram of one example of a system.

FIG. 19 illustrates worn out lanes on a track field.

FIG. 20 illustrates growth stages for corn.

FIG. 21 illustrates bounding boxes and center-lines for each bounding box.

FIG. 22 illustrates rows of corn plants with lodged roots.

FIG. 23 illustrates a corn harvesting operation.

FIG. 24A is an image of corn rows viewed from the side.

FIG. 24B is a simplified version of corn rows viewed from the side.

FIG. 25A is an image of corn rows viewed from a low mounted camera.

FIG. 25B is a simplified version of corn rows viewed from a low mounted camera.

FIG. 26 illustrates a stereographic camera mounted on a sprayer boom

FIG. 27 illustrates early season rows viewed from a camera mounted high on the vehicle.

FIG. 28 illustrates application of a Sobel operation applied to the image.

FIG. 29 illustrates central stalks of the plants highlighted.

FIG. 30 illustrates at top an image from a camera mounted on an agricultural vehicle, at the middle a highlighted region of interest for the image, at bottom the region of interest with perspective wrap applied.

FIG. 31 illustrates at top a Sobel operation applied to the region of interest, at middle an intensity graph for each column, and at bottom a binary mask indicating the center of each crop row.

FIG. 32 illustrates 4 crop rows in the region of interest which have been properly identified.

FIG. 33 is an image of a field where there are a plurality of rows with space between neighboring rows.

FIG. 34 illustrates a perspective transform of the image performed to linearize the image.

FIG. 35 illustrates the position of the plants.

FIG. 36 illustrates the position of the plants and the center of the space between neighboring rows.

FIG. 37 illustrates a projection of center of the space between neighboring rows onto a central open space chosen for guidance.

FIG. 38 illustrates one example of a method for estimating path.

FIG. 39 illustrates a more detailed example of the method for estimating path.

FIG. 40 illustrates an example of determining crop row spacing.

FIG. 41 illustrates one example of a system which may implement the methods shown and described.

FIGS. 42A and 42B illustrate a sample of the process for straight crop rows that have been subjected to a perspective warp.

FIG. 43 illustrates shapes of road signs and their uses.

FIGS. 44A and 44B illustrate a stop sign at a 4-way intersection with the feature highlighted and the center of the sign shown.

FIGS. 45A and 45B illustrate a sample image from a camera mounted on a tractor and the region of interest, ahead of the vehicle.

FIGS. 46A and 46B illustrate a sample of the process for straight crop rows in early season corn.

FIGS. 47A and 47B illustrate a sample of the process for crop rows that are curving to the right.

FIG. 48 illustrates space between rows defined by a polynomial.

### DETAILED DESCRIPTION

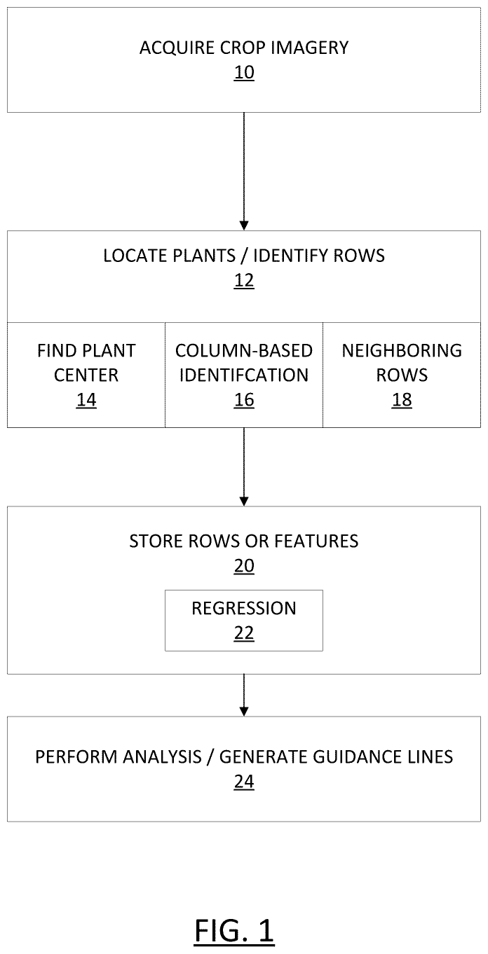

FIG. 1 illustrates one example of a method. In step 10 crop imagery is acquired. The crop imagery may contain a plurality of rows of crop. The crop imagery may be acquired such as through a camera or other image acquisition device mounted on an agricultural vehicle or implement.

In step 12, each of the plurality of rows within the crop imagery is identified. Identifying crop rows may begin with finding plant centers 14 and/or using column-based identification 16 and/or using neighboring rows 18. When crop rows or other features have been identified, in step 20 they may be stored. In some embodiments, a regression 22 may be performed in order to reduce the amount of space required to store the rows or other features. In step 24, an analysis may be performed which may include generating one or more guidance lines or other analysis which uses the location of plants, crop rows, or other features.

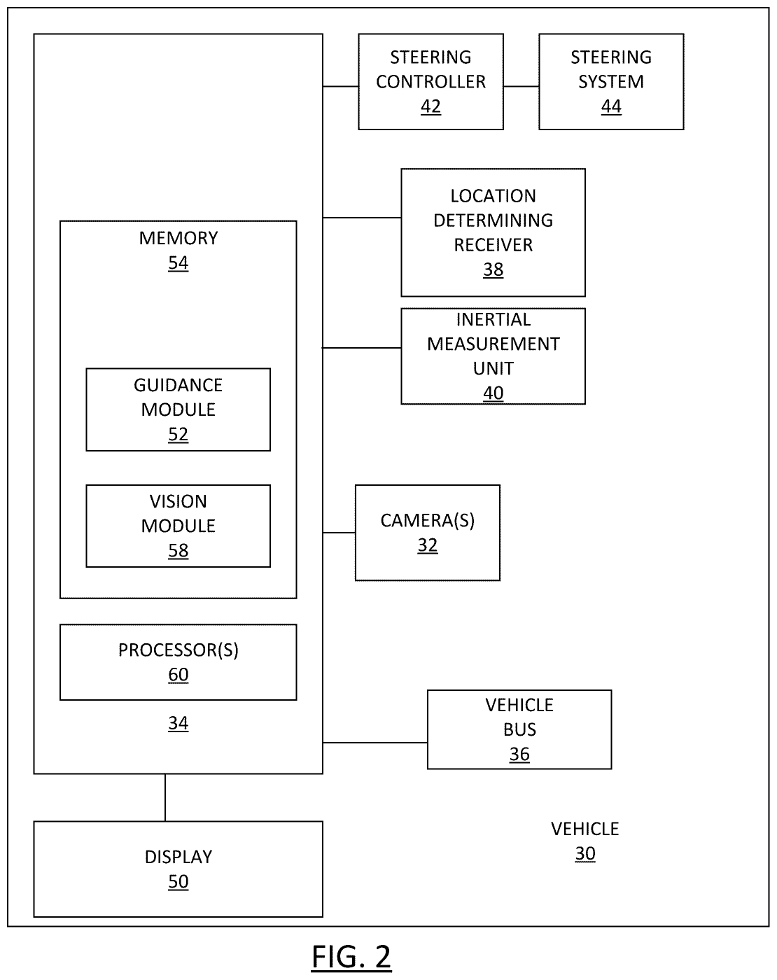

FIG. 2 illustrates one example of a system. In FIG. 2, a vehicle 30 is present which may be an agricultural vehicle such as a tractor. One or more cameras 32 are shown. One or more cameras 32 are also shown. The one or more cameras 32 may be operatively connected to a computing system 34. The computing system 34 may also be operatively connected to a vehicle bus 36. The computing system 34 may also be operatively connected to a location determining receiver 38 such as a GPS receiver. The computing system 34 may also be operatively connected to an inertial measurement unit 40. The computing system 34 may also be connected to a steering controller 42 which is connected to a steering system 44 of the vehicle 30. The computing system 34 may also be operatively connected to a display 50 which may be a touch screen display.

As shown in FIG. 2, the computing system 34 has a memory 54. The memory 54 may store computer readable instructions which may be executed on one or more processors 60 of the computing system 34. The memory 54 may store instructions associated with a guidance module 52 and a vision module 58 in addition to any number of other modules or sets of instructions. The guidance module 52 may be used to control operation of a vehicle such as to track a guidance line. The vision module 58 may be used to identify the location of plants, the location of crop rows, and/or to generate a guidance line which may be input to the guidance module 52.

The vision module 58 may include instructions for performing different types of processing including to identify centers of crop rows.

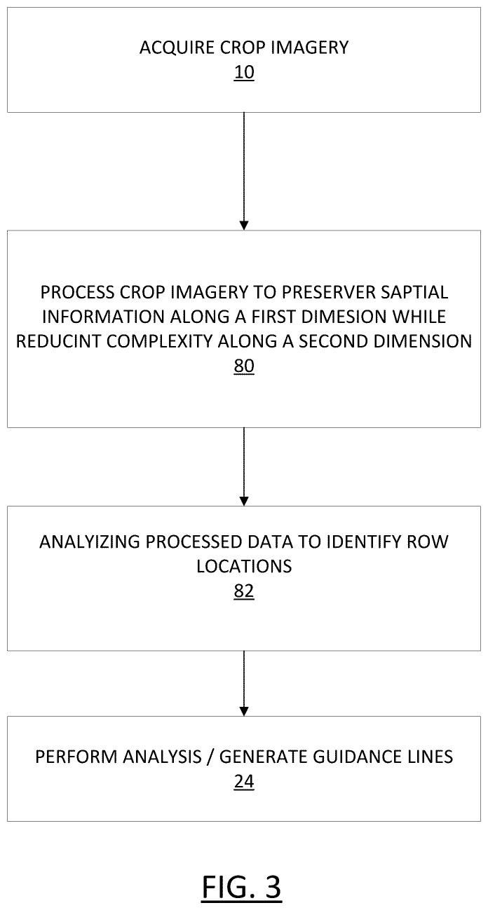

FIG. 3 illustrates a flowchart of a method for visually identifying crop rows. The method includes a step of acquiring crop imagery 10 from at least one imaging device operatively connected to an agricultural vehicle while the agricultural vehicle traverses a field. The acquired imagery includes a plurality of plants arranged in rows. The method proceeds to step 80 to process the crop imagery to preserve spatial information along a first dimension while reducing data complexity along a second dimension to generate processed data. This processing may include dividing the imagery into multiple sections along a direction of travel of the agricultural vehicle and performing statistical analysis for each section to generate a one-dimensional intensity profile such as in the column-based identification methodology shown in FIG. 1 and further described herein. Various embodiments and implementations are described herein, including methods that maintain different spatial relationships and utilize different approaches to dimensional reduction, but share a fundamental technical approach of selective dimensional reduction while maintaining essential spatial relationships for crop row identification. The processing may also include applying an edge detection operation to identify predominantly vertical features within the imagery and filtering out predominantly horizontal features to isolate plant stalks such as in the find plant center methodology shown in FIG. 1 and further described herein. The method continues with the step of analyzing the processed data 82 to identify row locations within the field. This analysis may include identifying peaks within the processed data that correspond to centers of the rows. The analysis may further include identifying spatial relationships between neighboring rows for validating row identification and dynamically determining row spacing based on these spatial relationships such as associated with the neighboring row method shown in FIG. 1 and further described herein. The method of FIG. 3 continues with step 24 which involves performing analysis and generating guidance lines. During this step, a mathematical representation of the identified rows may be generated using continuous functions for interpolating row locations between identified points. Where the imagery includes a region of interest ahead of the agricultural vehicle, steering commands may be generated based on the identified row locations. Plants deviating from the identified row locations may be identified and characterized as either weeds or volunteer plants. A guidance line, which may be curved, may be generated based on the locations of the rows within the field, and steering commands for the agricultural vehicle may be generated based on this guidance line. The analysis may be performed by a computing device onboard the agricultural vehicle.

### A. Column-Based Identification of Row Crops

As previously explained, one method which may be used in locating plants or identifying plant rows involves a column-based identification of row crops. As will be explained in further detail, this method generally involves processing the crop imagery to preserve spatial information along a first dimension while reducing data complexity along a second dimension to generate processed data. This processing may include dividing the imagery into multiple sections along a direction of travel of the agricultural vehicle and performing statistical analysis for each section to generate a one-dimensional intensity profile.

Before discussing the methodology in more detail, it should be understood that the problems presented in the agricultural field environment are different than those associated with automotive vehicles. For example, in an effort to improve driver assistance tools and vehicular safety, there has been a search for methods to identify and highlight road lanes. Various methods have been employed in an effort to accurately identify road markings and convert those into continuous lanes. While there are many car manufacturers and even more camera systems, most of the lane finding algorithms rely on a handful of methods.

One of the most popular and widely used relies on finding the edges of each feature in an image and then applying a Hough transform (HT) to find the straight line connections between edges. This methodology is well known in the art. HT's are robust when the lane marking or road features are consistent and clearly separated. Since there is usually a clear distinction between the smoothness of a road and relative unevenness of nonroad surfaces, there is reasonably low chance that this method would find a lane that is not on the road. Additionally, since road markings are usually white or yellow, they tend to have a high contrast with a dark road surface which facilitates the use of edge detection tools (such as Canny edge detection), thereby allowing for the use of HT' to appropriately find road lanes. One of the limitations of HT's is that they will return every ray that meets the specified criteria of point distribution and spacing, even if those rays are perpendicular to the direction of travel and are unrelated to the road lanes. As such, there is a certain amount of post-processing of the rays returned by the HT to get the desired road lane.

Similarly to the prior method, some lane identification processes rely on estimating the vanishing point in an image. This method works well if the camera is angled up far enough to be able to see the prospective change whereby one may estimate an image's point of convergence or vanishing point. One advantage of this method is that road lanes will appear to converge toward the vanishing point of an image and if the vanishing point is known then markings on the road that do not trend in the correct direction (e.g., pedestrian crossings) may be filtered out.

An approach to HT's, which also tries to minimize the probability of getting rays in unfeasible directions as vanishing point analysis methods do, relies on the use of scan lines. If one makes the, reasonable, assumption that the vehicle in question, and subsequently the mounted camera, is pointing in roughly the correct direction then it becomes possible to remove a lot of rays that would be output using a traditional HT. Thereby reducing the need for as much post-processing to get the desired rays. This is especially relevant if there are more potential lanes and the number of edges is high, as is often the case when steering along crop rows. Generally, this method relies on summing along the pixels crossed by a scan line and doing some analysis of the color of those pixels. This results in an intensity graph that may then be used to estimate the vehicles heading.

As previously mentioned, agricultural environments may prove to be challenging for the traditional lane identification methods that work well on roads. Whilst having multiple crops rows may give more lanes on which to validate a vanishing point or more boundaries on which to apply HT's, they may also make it easier to improperly identify lanes when weeds are present between rows since the size of each lane is much smaller than one get in road environments. Additionally, even if the aforementioned methods, when combined with additional filtering or post-processing, do provide a clean identification of crop rows, they are intended for use, solely, on straight rows and do not appropriately handle curves. When dealing with automobiles on man-made roads, the severity of a road's curvature is often low enough that using a HT to estimate road lanes as if they were straight still does well enough on a gradual curve. However, when dealing with planted row crops, the curvature of the planting paths is often much too severe to allow for accurate lane tracking when using methods designed for straight lines. As such, either a row finding product has to be released with caveats about how sharp a bend in the crop rows may be before the system fails to identify the rows or one accepts that the system will not always work as intended. Since neither of these are a good option, what is needed is a row finding methodology for use in agricultural environments that works in sharp curves without sacrificing the algorithm's accuracy when identifying straight crop rows.

The column-based method discussed herein, is an example of an improved method for identifying crop rows in agricultural settings by processing image data in a manner that deliberately maintains important spatial relationships while reducing complexity. Rather than attempting to identify geometric features directly within two-dimensional imagery, the method divides acquired imagery into sections and process each section to maintain spatial relationships in one dimension while collapsing or filtering data in another dimension. This approach enables identification of crop rows without requiring assumptions of straight lines, making it particularly effective for curved rows and varying field conditions. The method works effectively despite changes in camera mounting positions and perspectives, varying crop heights, and equipment configurations. The reduced-dimension processing approach also provides computational efficiency advantages important for real-time implementation on agricultural equipment.

### Overview

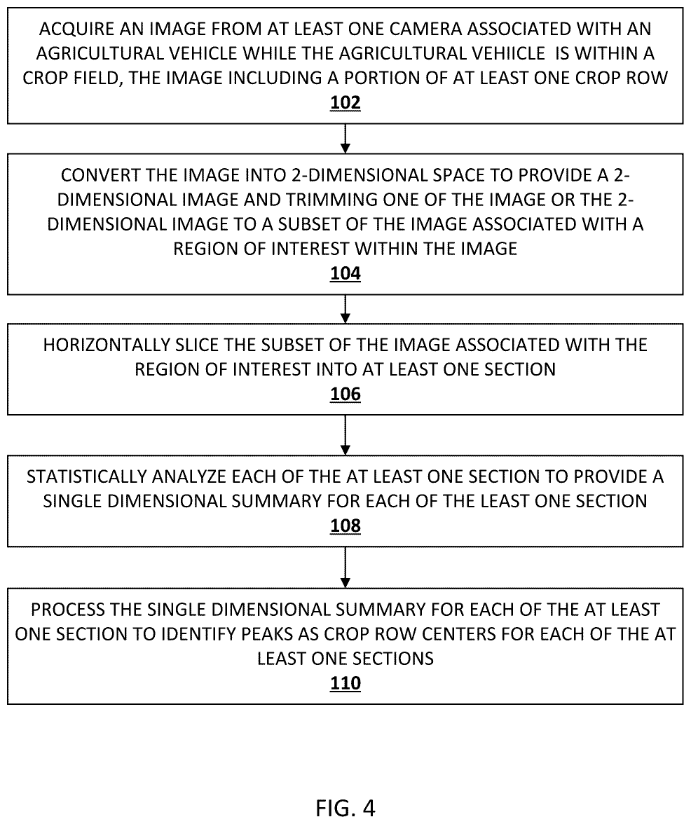

FIG. 4 illustrates a method for identifying crop rows which may be used with various types of agricultural equipment. The method begins at step 102, where imagery is acquired from at least one camera operatively connected to an agricultural machine. The imagery includes a plurality of rows within a field, with each row comprising multiple plants. The camera may be mounted in various positions on the agricultural machine, such as on a boom, on the roof, or in a forward-facing position.

At step 104, the acquired imagery is divided into a plurality of sections along the direction of travel. The size of these sections may be established based on factors such as the expected maximum curvature of the crop rows. In some implementations, adjacent sections may overlap by a predetermined amount to enhance the accuracy of the analysis.

At step 106, the method processes each section to maintain spatial relationships along a first dimension while collapsing spatial data along a second dimension to generate reduced-dimension data. This processing may be implemented in several ways depending on the specific application. In one implementation, the method maintains horizontal spatial relationships while performing statistical analysis on vertical strips within each section. In another implementation, the method maintains vertical spatial relationships while filtering out horizontal features such as leaves to identify plant stalks. In yet another implementation, the method maintains spatial relationships between adjacent rows while collapsing individual plant data.

At step 108, the method analyzes the reduced-dimension data to identify intensity patterns associated with the crop rows. This analysis may include identifying peaks in intensity values, determining spacing between intensity patterns, or analyzing relationships between adjacent rows. The specific analysis performed may depend on which spatial relationships are maintained in the previous step.

At step 110, the method combines the identified intensity patterns across the plurality of sections to determine crop row locations. This combination step may include validating patterns identified in one section against patterns in adjacent sections and does not require assumptions about straight lines. The method may dynamically determine row spacing based on the identified patterns across multiple sections.

Finally, after step 110, the method may be used to generate guidance commands for the agricultural machine based on the determined crop row locations. These commands may be used to steer the agricultural machine along the identified rows while minimizing crop damage. The method's ability to handle curved rows and varying field conditions without requiring straight-line assumptions makes it particularly effective for real-world agricultural applications.

This process enables reliable crop row identification despite challenges such as varying camera mounting positions, changing crop heights throughout the growing season, and different equipment configurations. The dimensional reduction approach also enables computationally efficient processing suitable for real-time implementation on agricultural machinery.

Various methods, apparatus, and systems associated with identifying rows, such as crop rows using vision, depth, or other frame data are disclosed. Generally, the methodologies relate to splitting an image or a subset of the image into columns and identifying crops within these segments.

Although different types of images may be used, in one example, a multidimensional color image is used and a method is applied for finding the rows of crops through the use of horizontal slices taken from the image (or of some sub-set of the image) and subjecting the data in the aforementioned slice to some statistical analysis such that we get a single dimensional array with information that may be used to find the centers of each row in each slice.

Note that, for the purposes of this disclosure, an RGB image may be considered a 3-dimensional image since the storage format for the data is m×n×3 where each of the three channels R, G, and B are individually m×n. For a common camera, m×n might be 1920×1080 but m and n may be any size. Similarly, a gray scale image may be considered to be two dimensional since the data would be in an m×n format. By extension, an RGBD or RGBA image may be considered to be 4-dimensional data or a 4-dimensional image. Finally, if just the depth data from and RGBD image is taken, even though the depth data would contain information about depth, it would still be considered to be 2-dimensional data so long as the data for the depth data frame is stored in an array of type m×n.

FIG. 4 provides an overview of one example of a methodology in the context of an agricultural vehicle with at least one camera to acquire images of crop rows. It is to be understood that various aspects of the methodology may apply in other contexts or applications as well. In addition, although the method and its options, variations, and alternatives will be described with more detail later herein, the method may include a series of steps such as those shown in FIG. 1. In step 102, an image is acquired from at least one camera associated with agricultural vehicle while the agricultural vehicle is within a crop field. The image includes a portion of at least one crop row. In step 104, the image is converted into 2-dimesional space to provide a 2-dimensional image and the 2-dimensional image is trimmed to provide a subset of the image associated with a region of interest within the image. Note that the conversion may occur before the trimming or the trimming may occur before the conversion. In step 106, the subset of the image is sliced into at least one section. It is to be understood that the orientation of the camera relative to the rows may vary and be compensated for accordingly. In step 108, each of the at least one section is statistically analyzed to provide a single dimensional summary. Then in step 110, the single dimensional summary may be processed for each section to identify peaks as crop row centers for each of the sections. The methodology may be performed in real-time while the agricultural vehicle traverses the field or post-processed after the vehicle has left the field, depending on the operation or purpose of finding the crop row centers. Once the crop row centers are identified they may be used in numerous and various ways such as to assist with vehicle guidance, perform agronomic evaluations or analysis or otherwise.

### Importing or Creating a 2-Dimensional Image

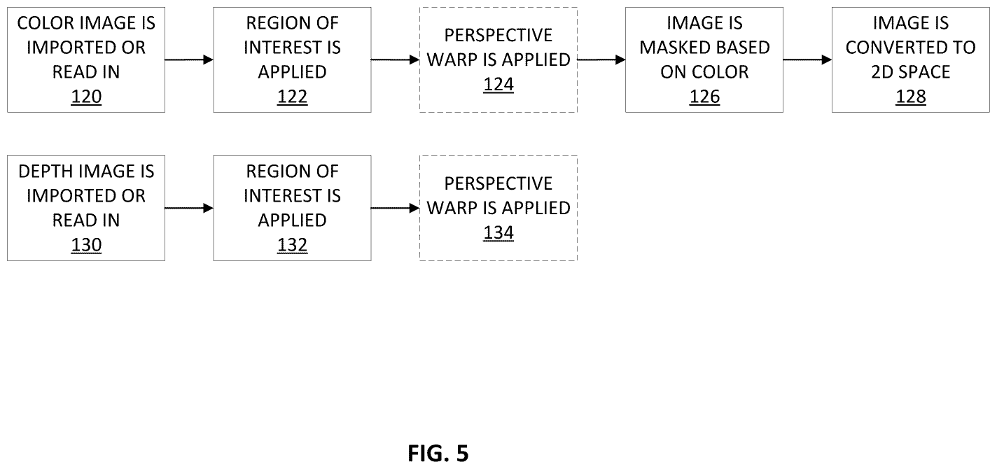

A 2-D image may be imported or created in various ways. FIG. 5 illustrates two examples of processes which will be described in more detail. In a first process beginning in step 120, a color image is imported or read in. The color image may be obtained through one or more cameras associated with a vehicle such as an agricultural vehicle. Next in step 122, a region of interest (ROI) is applied. Then optionally, in step 124, a perspective warp may be applied. In step 126, the image may be masked based on color. In step 128, the image may then be converted to 2-D space.

Alternatively, instead of a color image, a depth image may be used which may be acquired from a camera associated with a vehicle such as an agricultural vehicle. In step 130, the depth image is imported or read in. In step 132, a region of interest is applied. Then in step 134, a perspective warp is applied.

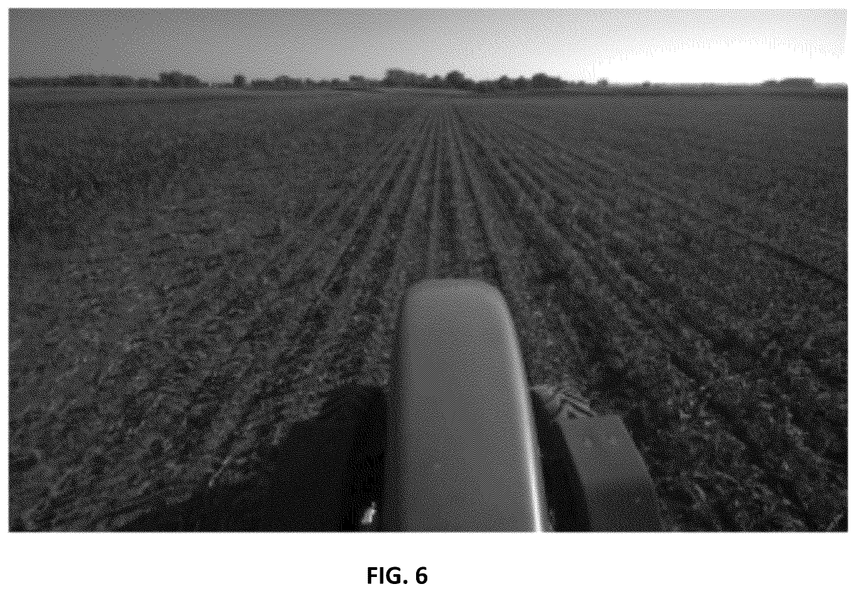

Given a camera mounted on an agricultural vehicle, wherein the camera is roughly in-line with the direction of travel of the vehicle, when the vehicle is in a field of row crops (e.g., corn or soybeans) a color image may be collected such as shown in FIG. 6.

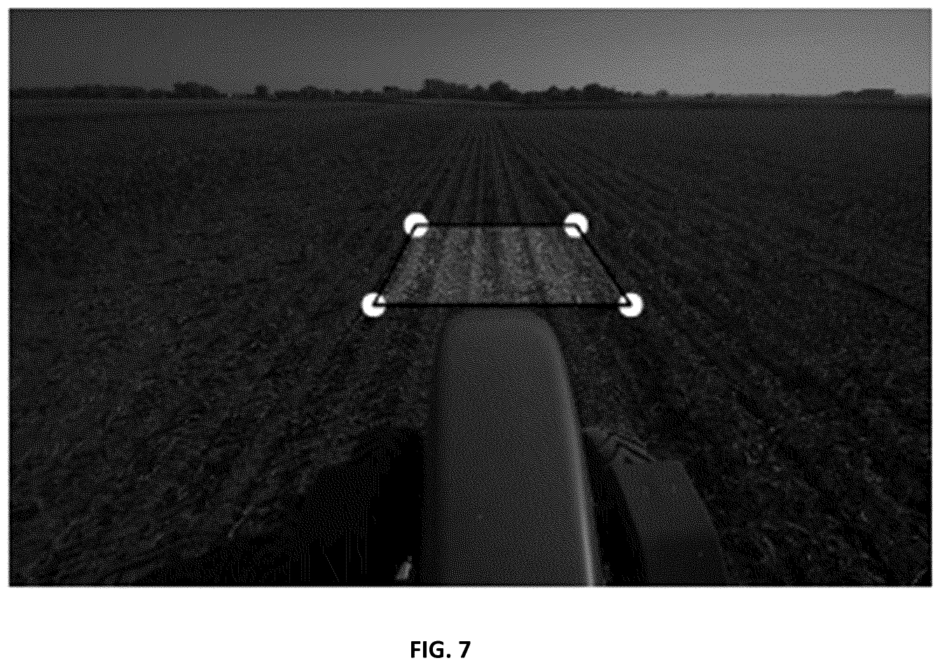

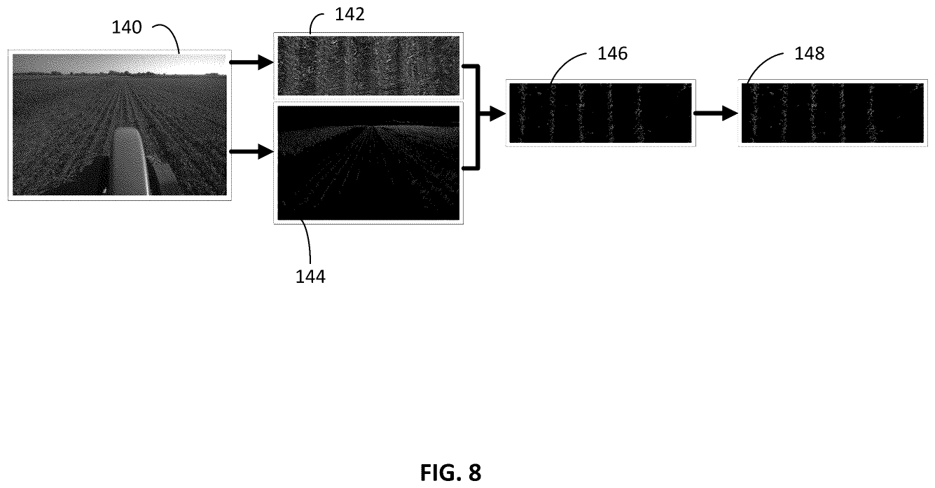

For various purposes, not all of the images may be desired or useful for a given purpose. For example, if one were to wish to steer along the rows of crops, it may be beneficial, from a computational standpoint or to mitigate issues due to lens warping, to only consider a sub-region of the full image. We will refer to this as the region of interest (ROI). An example of a ROI may be seen in FIG. 4. Without loss of generality, this region of interest may be user selected, as was the case in FIG. 7, it may be preset based on the position and orientation of the camera, or it may be chosen in some other way. Once the ROI has been chosen, the image may be processed in such a way as to generate a 2-dimensional image from a multi-dimensional input image. This may be done in several ways. For example, it may be achieved by converting the image to gray scale, removing the red and blue data from a RGB image thereby leaving only the green channel, converting the image into either the HSV or HSL format and then discarding all the non-hue data, just to name a few. It is contemplated that any number of methods may be used to perform such a dimensional conversion. Two such examples are shown in FIG. 8. Going from left to right, in FIG. 8, it is shown that the multi-dimensional color image 140 is read in and a 2-dimensional subset of that image is output. One may apply a color mask to result in an image 144 before trimming the image down to the region of interest or as shown in image 142 the original image may be trimmed down to just the ROI before any mask is applied. Thus, without loss of generality, the order of operations for applying a color mask, and indeed converting the image into gray-scale, is freely interchangeable with trimming the image down to only the ROI. It should be noted that, in FIG. 8, not only is the original image trimmed down to just the region of interest but the region of interest 146 (which is trapezoidal in nature as shown in FIG. 7) then has a perspective warp applied to it to result in image 148. This perspective warp is chosen such that the vanishing point of the image is largely compensated for resulting in a rough approximation of a bird's eye view of the crop rows. While this perspective warp may be helpful and is easier to visualize, it is not necessary for this methodology to work. This methodology is also shown in FIG. 5. For the purposes of this example, a color mask was applied to a RGB image by first converting the image to HSL format and then limiting the range on the hue channel to just the green spectrum. This resulted in a mask that largely removed the dirt, vehicle, and sky and left just the plant or vegetation.

[35≤H≤80, 0≤L≤255, 75≤S≤255]

for each of the three channels, a variety of other masking methods may also have been used. For example, one may choose to solely mask based on the hue and not have any conditions on the color's saturation, resulting in a mask with the following parameters

[35≤H≤80, 0≤L≤255, 0≤S≤255].

Additionally, one may also choose to expand or contract the range of the mask on the hue channel to allow for greater or lesser variations in colors of the vegetation being viewed. The resultant 2-dimensional image may be used as discussed later herein. Note that, since a 2-dimensional image is needed for the analysis in the following section, this same process may be performed with a depth frame so long as the depth date was provided as a 2-dimensional depth frame or may be converted into one. In this case, the region of interest would be applied to the depth frame and the corresponding sub-image may be used for the analysis as discussed later herein. As with a color image, whilst a perspective warp, may be helpful, it is not necessary. To convey this, the last step in FIG. 5 is shown with a dashed border. It follows that the same may be said for any 2-dimensional image, one possible example would be a thermal image.

Additionally, similar methods to those discussed for down-sampling a 3-dimensional color image may be used for data with additional dimensions. For example, an RGBD image such as those generated by a stereographic camera may be used by simply throwing away the 4th dimension of depth data, thereby getting to a 3-dimensional color image and then following the process shown. In the case of Red-Edge cameras which produce 5-dimensional data, by including near infra-red and near-ultraviolet data as additional dimensions, one may use just the near infra-red, just the near ultraviolet, or the standard RGB data with the down sampling as previously discussed. With this in mind, it should be clear that, without loss of generality, a thermal image may also be used.

### Slicing a 2-Dimensional Image

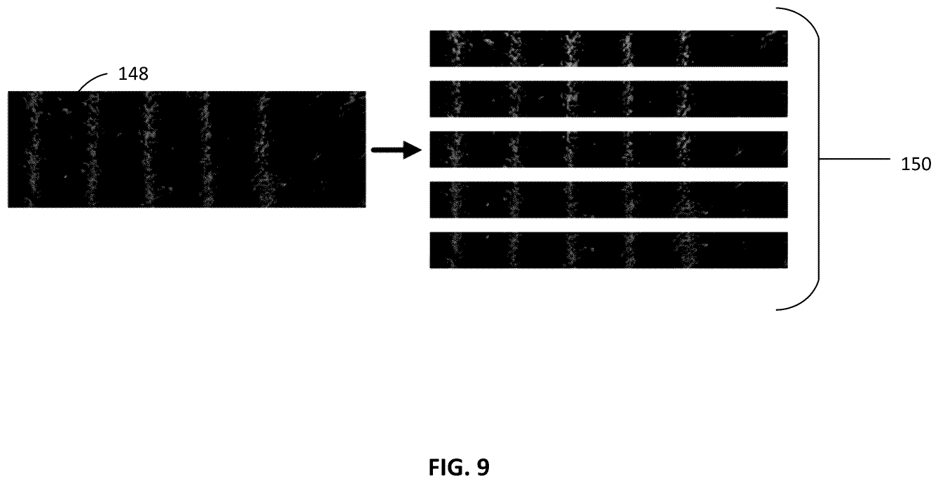

Once we have a 2-dimension image or sub-set of an image, that image should be partitioned horizontally into 1 or more slices. These slices may be created based on some set number of pixels per slice and may be chosen such that there is no overlap between slices or such that there is some overlap between adjacent slices. FIG. 9 depicts a 2-dimensional gray-scale image 148 of crop rows as generated using the process shown in FIG. 8 being segmented into 5 individual sections 150. In this particular case, the height of each segment was 50 pixels and there was a fifty percent overlap with adjacent slices.

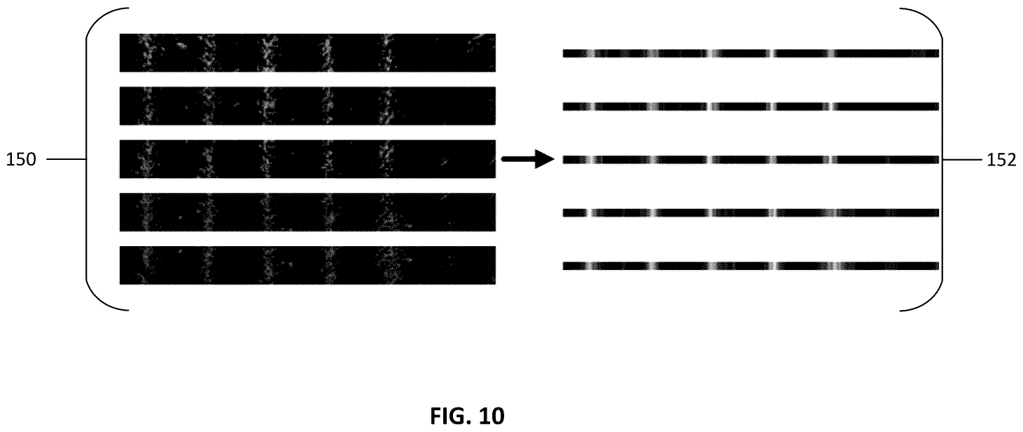

Each individual slice may then be compressed down from a 2-dimensional array into a single dimensional one as shown in FIG. 10 where each of the 5 individual sections 150 are compressed into slices 152.

This may be accomplished by summing, averaging, or conducting some other statistical method to each column or group of columns of the 2-dimensional slice. An example of this wherein each column of each slice 152 is averaged may be seen in FIG. 10. For this example, each slice was 50×500 pixels and the resultant 1-dimensional array therefore has a dimensionality of 1×500 pixels. Without loss of generality, the starting height and width of each segment may be any value. Groups of adjacent columns may also have been used and the size of the resultant array may then be 1×n where n≤500, for the example given. Adjacent columns being included in the statistical analysis for a singular column, may mitigate noise due to leaves, weeds, or other environmental factors. Alternatively, the 1-dimensional signal may be filtered to produce a similar result as discussed later herein.

The number of horizontal slices and the amount of overlap between segments should be chosen based on field conditions. If the rows of crops are known to be straight and there are no curves in the field, then less slices may be used while still ensuring that the center of a given row may properly be identified. In fact, if the case where the rows are known to be perfectly straight and a perspective transform is applied to the image such that a bird's eye view of the ROI is approximated, using only 1 slice (i.e. using the whole ROI as opposed to segmenting it further) would provide as much useful data as multiple slices and would reduce the computational expense associated with additional analysis. If, however, there is a significant curve in the crop rows, then multiple slices would be desirable to ensure that the curvature of the row may be identified.

Additionally, if the crop data is clean, there is no need to have any overlap between slices and the computation is slightly faster as a lower number of total pixels will be analyzed. However, if there are sections of missing plants, having a larger slice with some overlap between it and adjacent sections may help bridge the gap cause the missing plant. Similarly, if there is a significant amount of weed pressure, in the ROI then having some overlap between slices may mitigate the high points cause by the greenery of a weed since the presence of a weed in between rows would be balanced out by the soil above and below the weed.

### Finding the Centers of the Rows

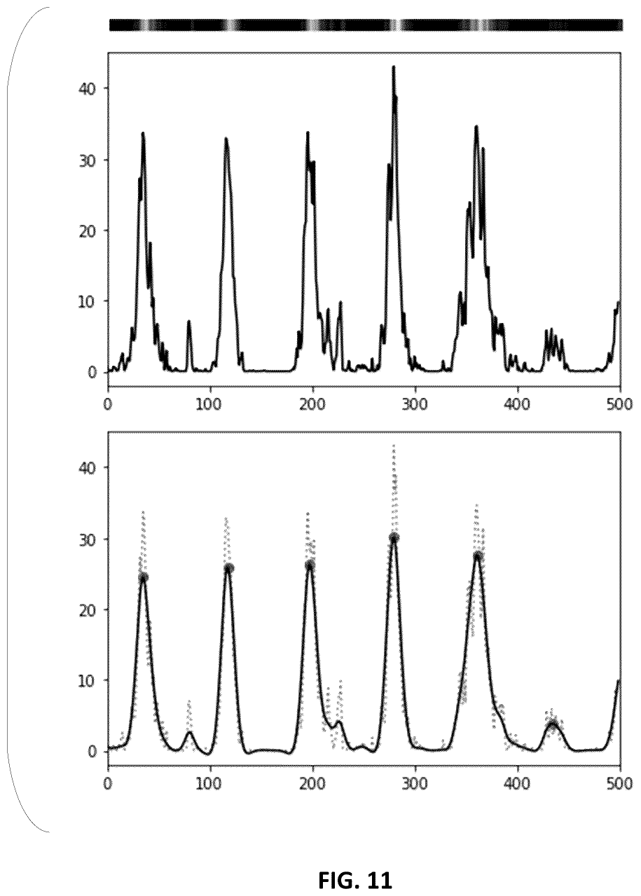

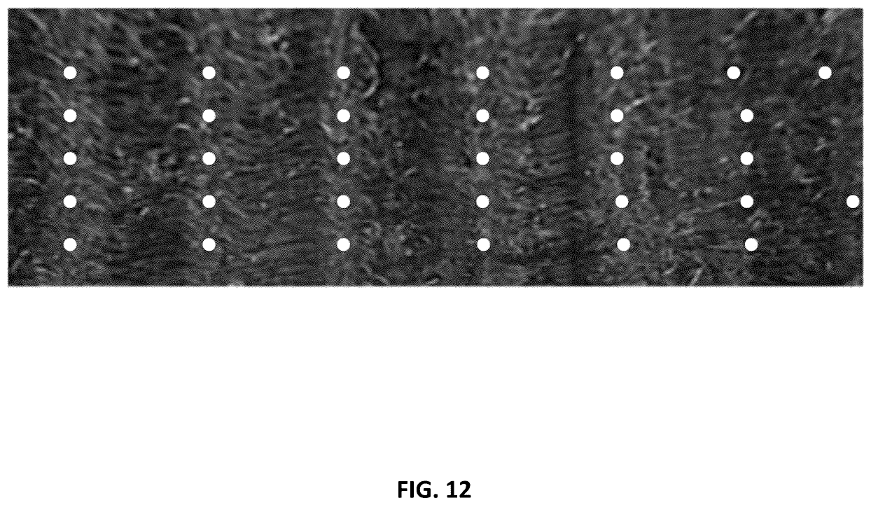

Once one has a singular row of data representing a singular horizontal slice of the 2-dimensionalized ROI, that data may be represented in a standard graphical form. As shown in FIG. 11, the data may be fairly noisy. Thus, one may want to filter the data to facilitate the identification of peaks and troughs in said data. In this case, since the original image was masked in such a way as to keep only the green sections of the image, the peaks over a singular slice represent plants. If, however, a depth data frame was used, then the troughs would represent the plants since they would be closer to the camera than the soil would be, resulting in a lower average distance when the distances in a singular slice were summed up. Thus, solely for the purposes of visualization and without loss of generality, we may see the peaks, which represent crops, for a singular slice in FIG. 11. Note that the centers of each have been highlighted as the centers of each peak correspond to the center of each crop row for a given slice. If this same process is repeated for each of the five slices depicted in FIG. 10 and then each of the peaks found is then overlaid on the original color ROI, the results may be expressed as an image like the one shown in FIG. 12.

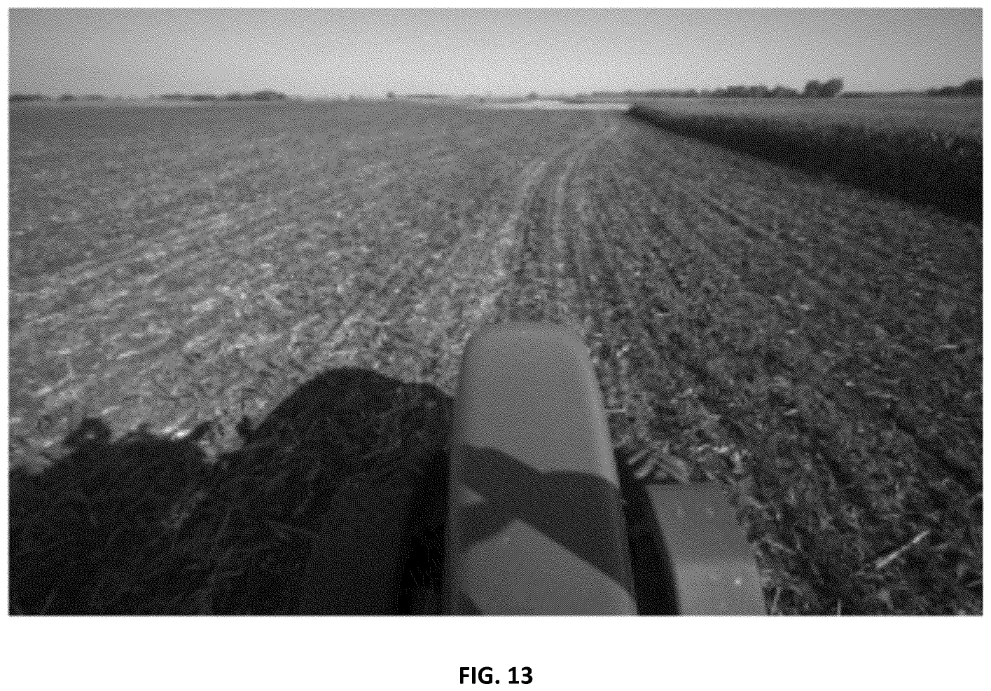

As previously discussed, for this particular case and since the crop rows are reasonably straight, one may choose to use fewer horizontal slices than the five that were used. However, to compensate for differing lighting conditions or for crop rows planted along a curve, as depicted in FIG. 13, five horizontal slices of the ROI may be the minimum amount needed to be able to compensate for leaf noise, weeds, and path curvature.

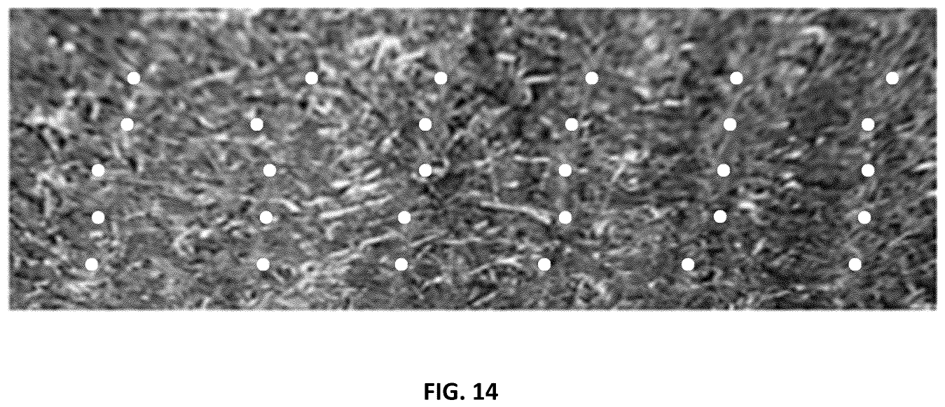

As shown, in FIG. 14, how applying a curve fit to each of the sets of points for each crop row would produce a reasonable estimate for the center of each row. However, the second row from the left has a singular plant that is offset from the expected center of the row which may cause the curve fit's quality to degrade slightly. Thus, using more slices or having more overlap in-between slices may be useful in this case. For the sake of visualization, 5 points per row is often useful in that it conveys the message without over cluttering the image. However, in practice, it was found that using around 20 to 30 horizontal slices tended to produce the best results across most lighting conditions, crop types, growth stages, and curvatures of the planting rows.

### Using the Centers of the Rows

There are a variety of applications for knowing points along the center lines of individual crop rows. A few of these are discussed, however, one skilled in the art having the benefit of this disclosure will appreciate that the methods and systems shown and described may be used in any number of different applications.

### Vehicle Guidance

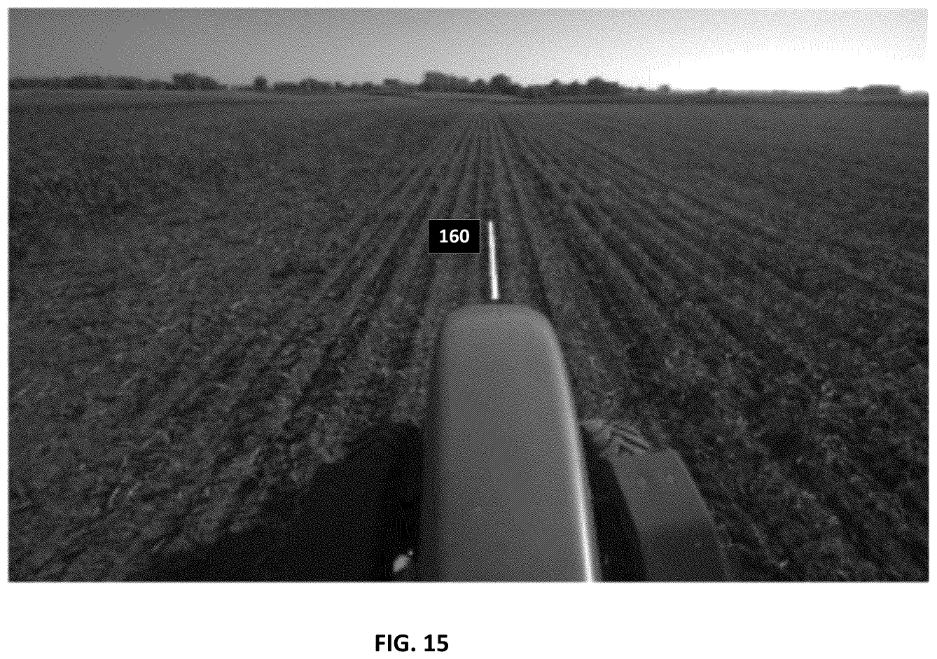

One clear application is fitting a line along the points for each row and getting an approximation of the center line for each row. Similarly, to finding lanes on a road, once one obtains the center line for each crop row, several processes may be used for guidance. For example, the center line between two rows may be used as a guidance line, such as the guidance line 160 shown in FIG. 15.

Alternatively, the heading error between the vehicle and the center line between rows may be used to compute necessary steering corrections. Similarly, if the position of camera relative to the vehicle is known, the offset error of the vehicle due to the center of a row (commonly referred to as cross-track error) may be calculated and used for various common steering methodologies.

### Agronomic Analysis

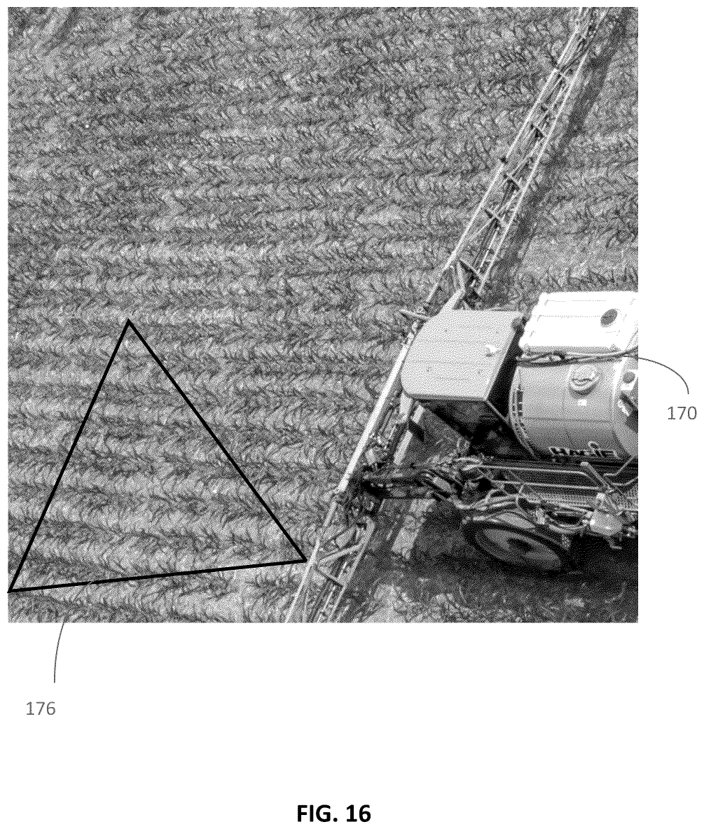

Another application may be the identification of missing plants or plant quality or other agronomic analyses or evaluations. For example, as shown in FIG. 16 an agricultural vehicle in the form of a self-propelled sprayer 170 may have a plurality of cameras mounted thereto. A field region 176 within the field of view of one camera is shown.

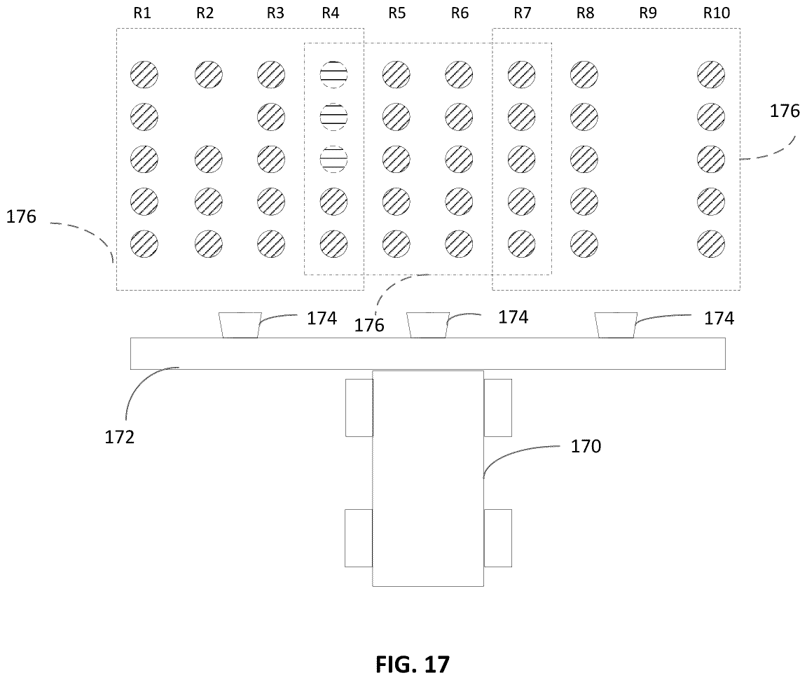

FIG. 17 further illustrates the agricultural vehicle in the form of a self-propelled sprayer 170 with boom 172 with a plurality of cameras 174 mounted along the boom 172. Each of the plurality of cameras 174 is positioned to view a different field region 176 with some overlap between field regions 176 as shown.

For example, if the size of horizontal slices was properly chosen, it would be possible to identify when a plant was missing from a row. For example, if one were to examine FIG. 17, it should be clearly visible that the row R2 is missing a plant that are present in the other rows. This may be due to the plants not germinating, the plants falling over due to environmental effects, pests, or some other reason. Whatever the cause, it may be useful from an agronomic standpoint to be able to identify when individual plants are missing.

An entire row of crops R9 may be missing due to a clogged seed meter during the planting operation, due to crops being run over during spraying, or poor soil compaction. Low crop health such as reflected in row R4 may be due to lack of fertilizer, weed pressure, or issues arising from pests, just to name a few environmental conditions affecting crop health.

Thus, it should be clear that a similar analysis may be used to identify when a whole row of plants is missing as shown for row R9, when a singular plant is missing as in row R2 or even when certain plants are not healthy relative to their neighbors as depicted in row R4 by the difference in pattern representing differences in the crop.

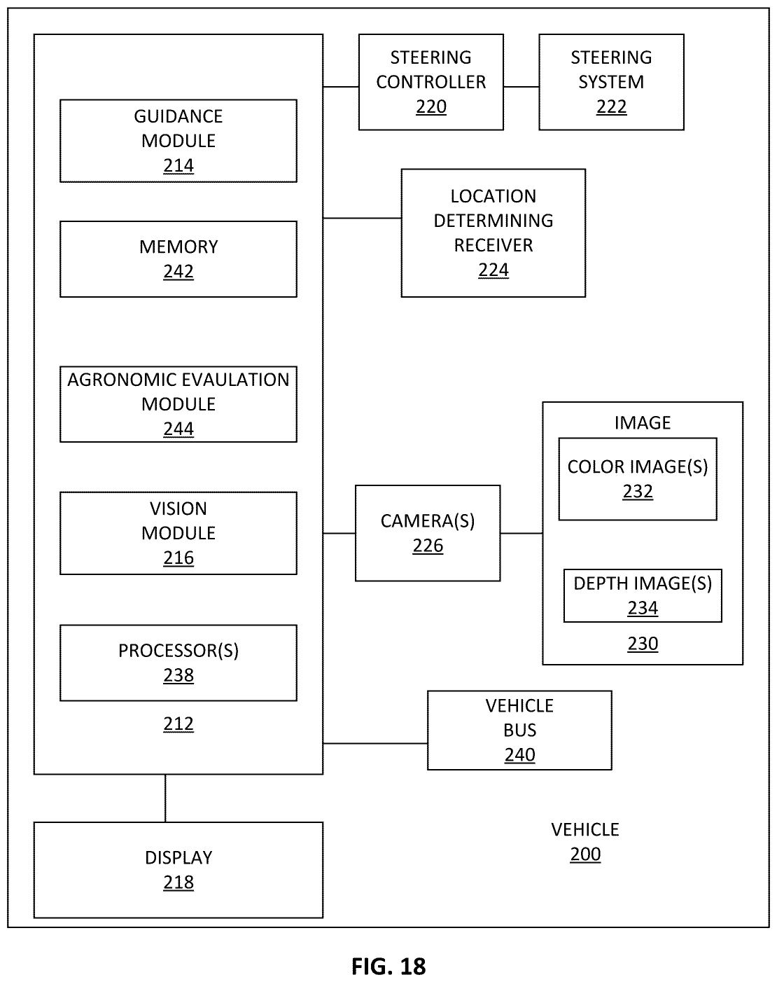

FIG. 18 illustrates one example of a system which implements the methodology shown and described. In FIG. 18, a vehicle 200 is shown which may be an agricultural vehicle such as a sprayer, tractor, vehicle and implement, vehicle with attachment, or other type of vehicle. A controller 212 which may be a computing system with one or more processors 238, a memory 242 which may include one or more separate memories, and one or more modules. The modules may be implemented in hardware, software, or combinations thereof. For example, each of the modules 214, 216, 244 may be a set of instructions stored in memory 242 for execution by the one or more processors 238. Examples of modules may include the vision module 216, a guidance module 214, and an agronomic evaluation module 244, however other modules are contemplated for performing different functions and fewer modules may be used.

A display 218 may be in operative communication with the controller 212 which may be used to display maps, imagery, instructions, display information, and receive user input where the display is a touch display. One or more cameras 226 are shown such as those previously described or to acquire images of the type previously described. Images 230 may, for example, be color images 232, depth images 234, thermal images, or other types of images. The vision module 216 receives imagery from one or more cameras 226 and processes the imagery according to methods such as those described herein which may be implemented in software instructions, hardware, or a combination thereof.

As shown in FIG. 18, the controller 212 may be operatively connected to a vehicle bus 240 and communicate information across the vehicle bus 240. Although some elements shown in FIG. 18 are shown directly connected to the controller 212, it is to be understood that various elements may be connected directly to the vehicle bus 240 instead or otherwise indirectly connected or otherwise operatively connected to the controller 212.

A guidance module 214 is shown which may be used to generate a guidance line, modify a guidance line based on analysis from the vision module 216 or otherwise. For example, the vision module 216 may use the methods previously described to determine row location which may be used by the guidance module 214. The guidance module 214 may provide commands, instructions, or input to be used by a steering controller 220 to control the steering system 212 of the vehicle. A location determining device 224 such as a GPS receiver may also be in operative communication with the controller 212.

An agronomic evaluation module 244 may be used to implement methods such as those previously described such as to identify missing plants, poor plant health, or other observations. Results of any number of agronomic evaluations or analyses may be stored in the memory 242, shown on the display 218 or later communicated somewhere else. Alternatively, such information may be used immediately. For example, if a plant was determined to be in poor health due to needing fertilizer or pesticide, an appropriate amount of fertilizer or pesticide may be applied in real-time.

Uses outside of Agriculture

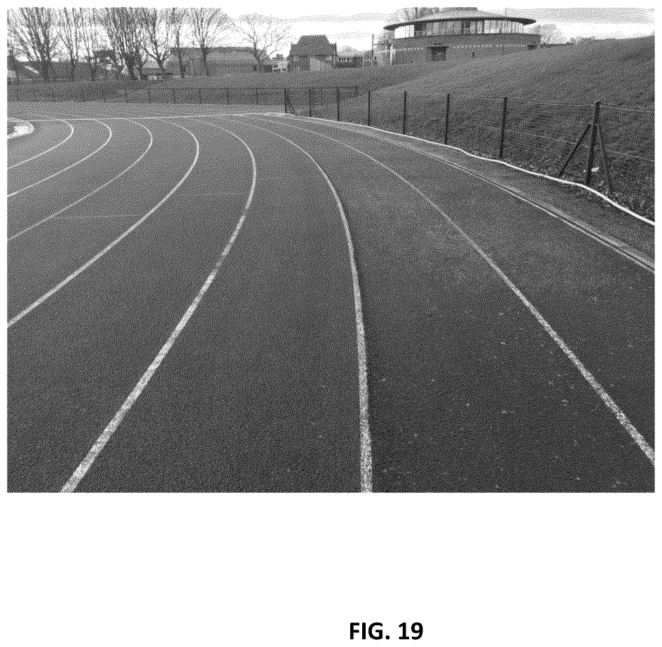

Similarly, if this process were to be used in a warehouse setting with tape or paint on the floor, in a parking lot, or on a road where multiple lanes may be seen, this process may be used to identify where the paint has worn down and needs to be replaced. Thereby allowing precision fixes as opposed to wastage due to repainting sections that are in good condition. An example of this may be seen in FIG. 19 where some sections of the track lanes may do with repainting since they have fully worn down whilst others are in usable condition and repainting them early would incur an unnecessary expense. Thus, it should be apparent that the methodology has other uses, may be used with other types of vehicles including agricultural vehicles, warehouse vehicles such as forklifts, construction vehicles such as striper trucks, autonomous and semiautonomous vehicles, and the like.

### B. Center of Plant Finder

According to another aspect, the centers, or stalks of row crops, such as corn are found by removing horizontally oriented portions of an image to get rid of leaves and keep vertically oriented portions to identify the stalks.

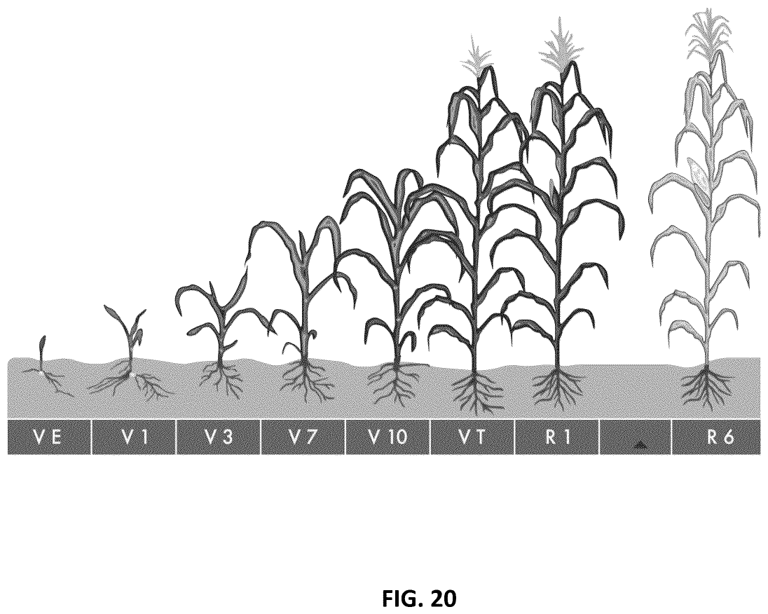

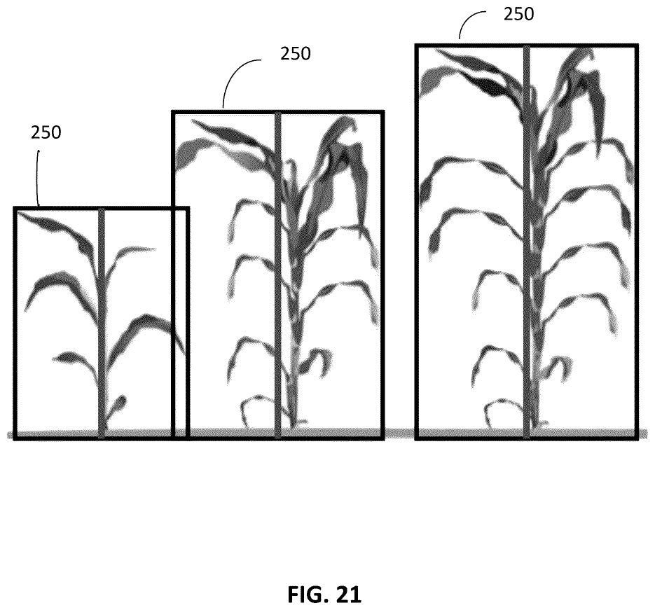

There are many reasons for which one would want to be able to locate plants in an image. As such, there has been quite a bit of work done to train segmentation models to find and identify different plants. Many of these models return a bounding box around a plant or series of plants. While this is often sufficient for the purpose of finding a plant, bounding boxes present some issues if an image is to be used for more advanced purposes. FIG. 20 shows the different growth stages for corn and also serves to show how, after a certain stage, delineation between plants may be difficult since the leaves will overlap those of plants on neighboring rows (generally referred to as canopy). If one were to try and place bounding boxes around each individual plant after canopy, even when viewed from the side (as in FIG. 1), a singular bounding box may improperly bound multiple plants or bounding boxes would overlap, as depicted in FIG. 21. Therefor merely setting a path planning algorithm that relies on steering between bounding boxes would only work in early growth sages (pre-canopy).

If one were to try and compensate for overlapping bounding boxes by steering between the centers of neighboring bounding boxes, one may also have sub-par performance as the center of a bounding box may not line up with the stalk of a given plant, as demonstrated in FIG. 21. In which case, driving between the centers of bounding boxes would result in driving off of the center of a row which risks damaging plants.

Thus, for the purposes of steering between rows of crops whilst minimizing the risk of damaging plants there is a clear benefit to being able to find the central stalk of a plant.

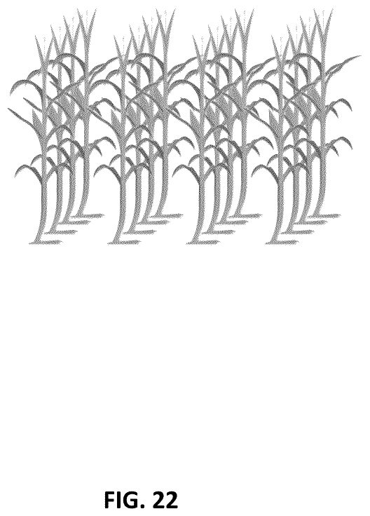

Additionally, in the case where crops might have been subject to root lodging, wind damage, hail, pests, or some other factor that affected the growth of the plant, it would be beneficial to be able to automatically identify when a plant's stalk is not vertical. This may be used for agronomic purposes or in the event that automatic steering were still feasible, for steering while minimizing further damage to the crops. For example, in FIG. 22 we see a row of corn plants with lodged roots. If one were to drive between the location of the root balls, one may risk hitting the plants with the vehicle tires or the body of the vehicle. However, if one were to drive between the upper sections of the corn plants, which are upright, even though one would not be centered between crop rows one would be centered between the stalks of the plants and thereby reduce the risk of further damage to the plants.

One identifiable feature for every growth stage of a healthy plant is that the central stalk is vertical as seen in FIG. 20 and the same holds true even for some crops that have recovered from issues early in their growth as seen in FIG. 22. The leaves of a plant, however, tend to splay to the sides. This is beneficial for the plant as it exposes more of the leave's surface area to the sun and facilitates the collection of nutrients. Both of these features of plants may be exploited to find the central stalk of the plant, through the use various methods to find the vertical features in an image as those vertical features should be associated with stalks of crops.

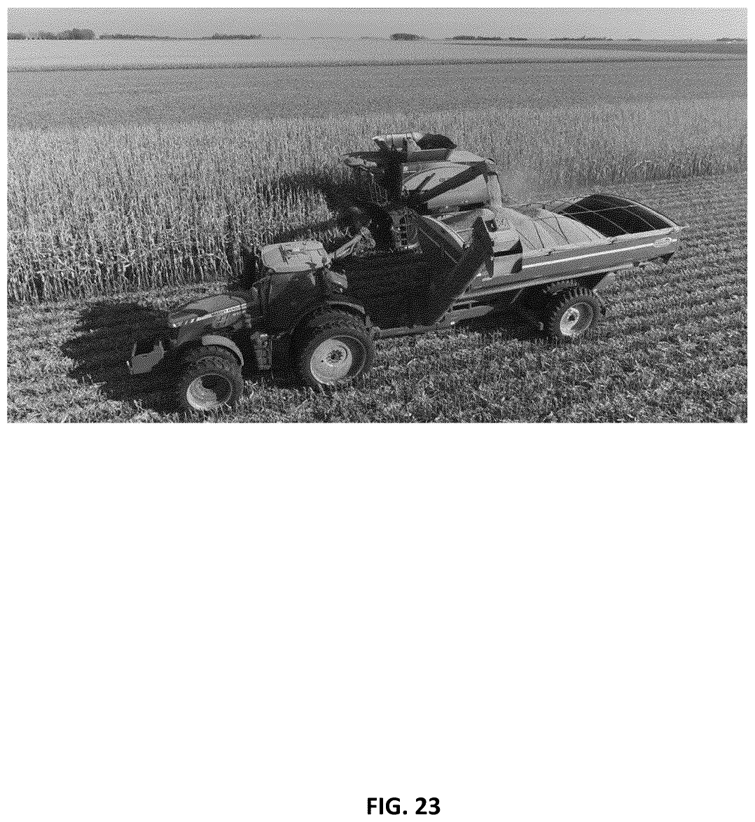

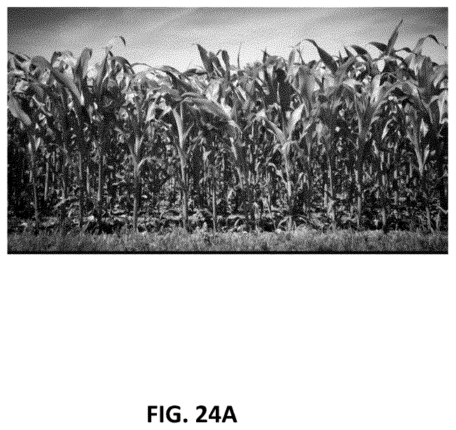

Depending on the mounting location for an image capture device, the image or the crops will look significantly different. For example, if a camera were mounted onto the side of the tractor shown in FIG. 23, one would see something like the view shown in FIG. 24A.

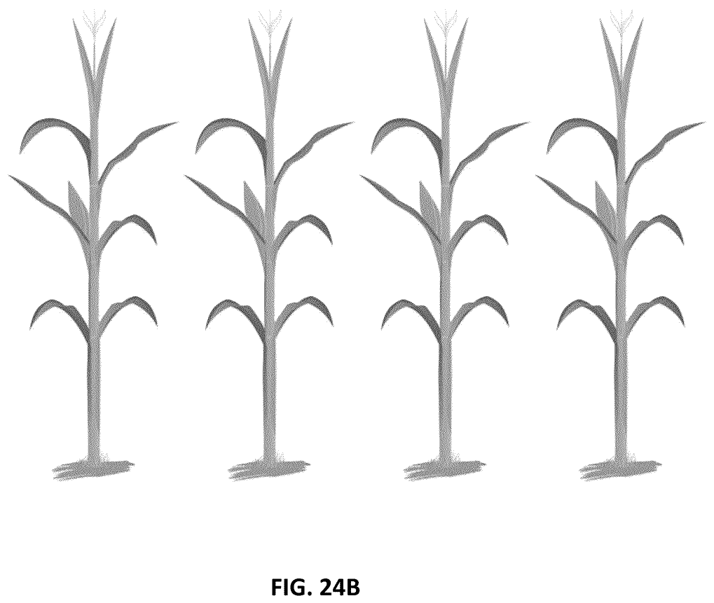

However, if a camera was mounted such that the camera was inline with the vehicle' s direction of travel and it were mounted close to the ground such that the camera would traverse under the canopy (for later growth stages) and close to the plants (for early growth stages), one would get images like FIG. 25A.

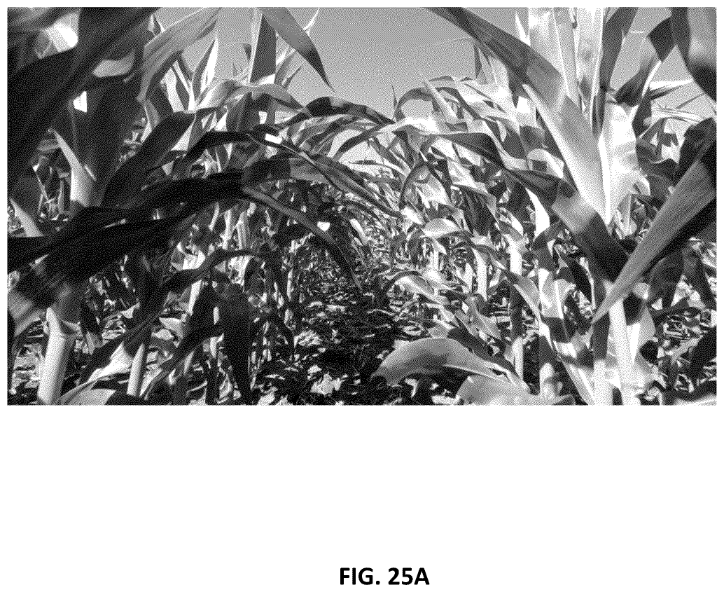

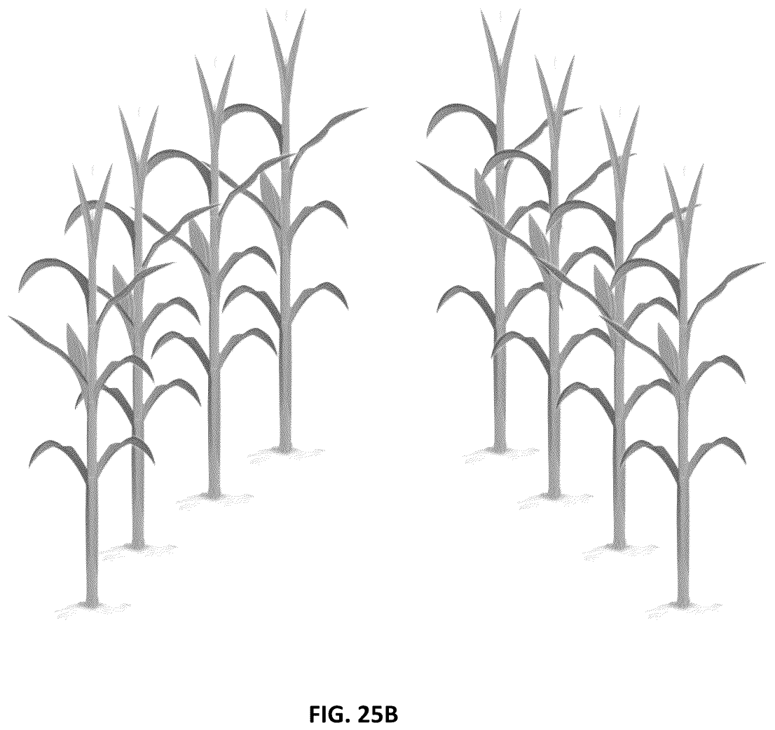

Finally, if a camera were mounted high on a vehicle, such as on the boom of a sprayer (as depicted in FIG. 26) or the roof of a tractor one would get a view like the one shown in FIG. 27.

### Vertical Portions of a Simple Image

For the sake of demonstration, if one were to take the simplified versions of the corn rows for both low mounted camera, as depicted in FIG. 24B, then the following process may be used to find the stalks of corn.

First, a process to separate the vertical features from horizontal features in the image should be applied.

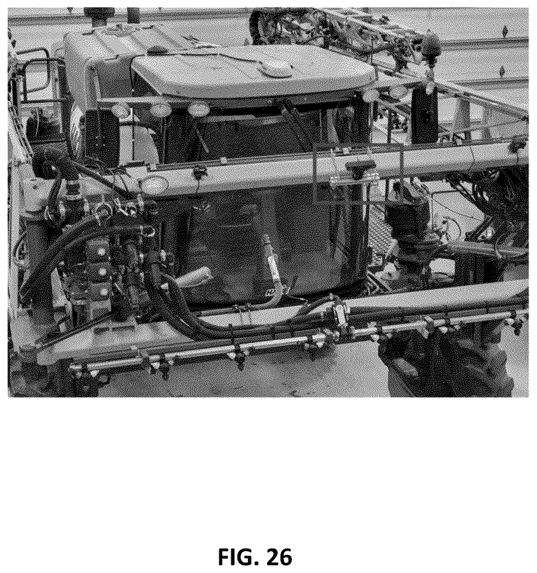

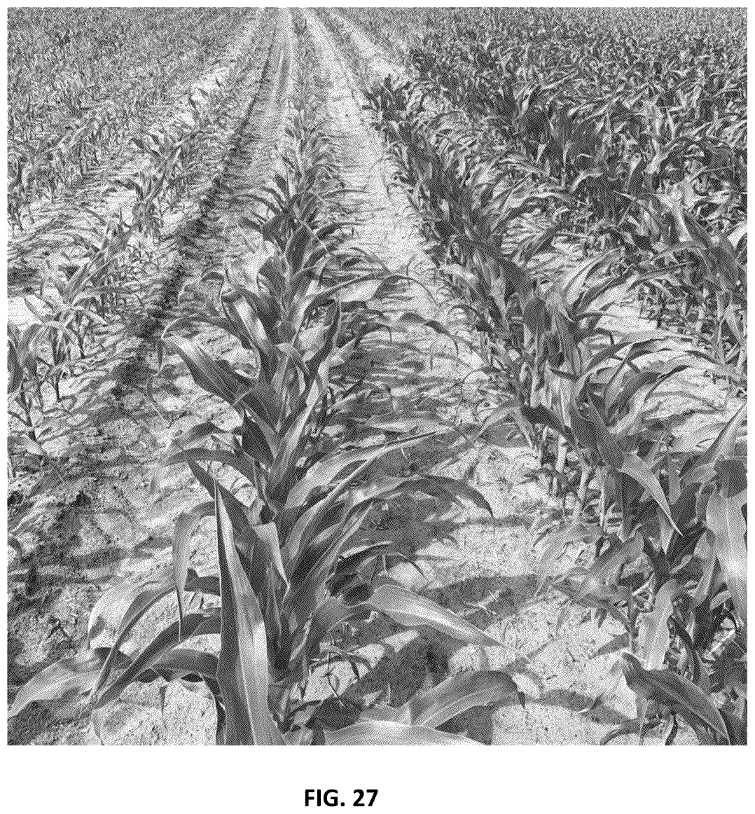

Without loss of generality, we may apply the Sobel operation onto the original image and keep just the vertical component of the image. Doing so would return an image like the one shown in FIG. 28. Examining the result, we may see that the central stalks of each plant have been highlighted and the leaves which are largely horizontal have been ignored. This result may be used directly as a mask and applied back on the original image to get FIG. 29. Other methods that may be used to find the vertical components of plants are Prewitt edge detectors, Laplacian edge detectors, and Canny edge detection methods. Note that this list is not exclusive as there are many methods that would suffice including various AI or machine learning methods. The application of the vertical line identification methods as applied to crops or agricultural settings is, until now, unexplored.

### Finding Rows of Crops From Above

Whilst the application of these methods is somewhat more difficult in cluttered environments than in the simplified example previously shown, with the right parameters and careful tuning, this method provides excellent robustness in a variety of environments. This is true irrespective of plant color, ambient lighting (assuming there is enough light for the plants to be seen), or crop growth stage. This method also work across a variety of image capture devices (e.g., color cameras, stereographic cameras, infra red cameras, lidar sensors that return a 2 dimensional image made from the depth data, near edge cameras, etc.) so long as vertical features may be distinguished from non-vertical ones.

To show this we will look at the view from a camera mounted above the crop canopy in late season corn that has not yet tasseled as provided by a color camera. Note that after tasseling, this method is even more robust as the corn tassels are seen as thin and vertical lines in an image which is precisely what we are trying to identify.

Thus, the example being shown in this section represents some of the most difficult scenarios for this method and is a good example of the methodology's robustness.

For the purposes of demonstration but without the loss of generality for other applications, we may take an example wherein we have a camera mounted on the roof of a tractor and aligned with the direction of travel for that tractor. In this example, we want to identify a series of crop rows in front of the vehicle for the purposes of steering between the rows. The view from the camera, the associated region of interest (in which we would like to find the crop rows), and the region of interest after being subjected to a perspective warp may be seen in

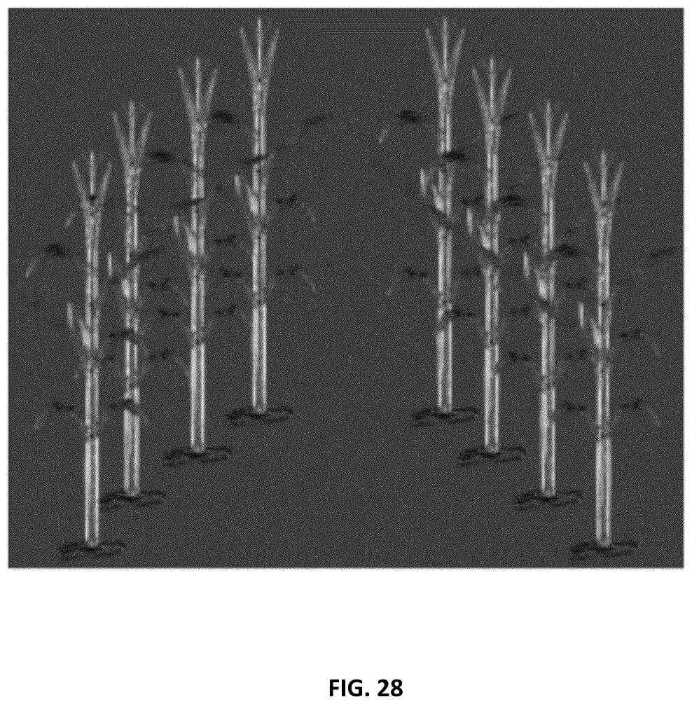

FIG. 30. It should be noted that applying a warp to the image is not necessary but it does make the process simpler and makes the visualization more clear for the reader.

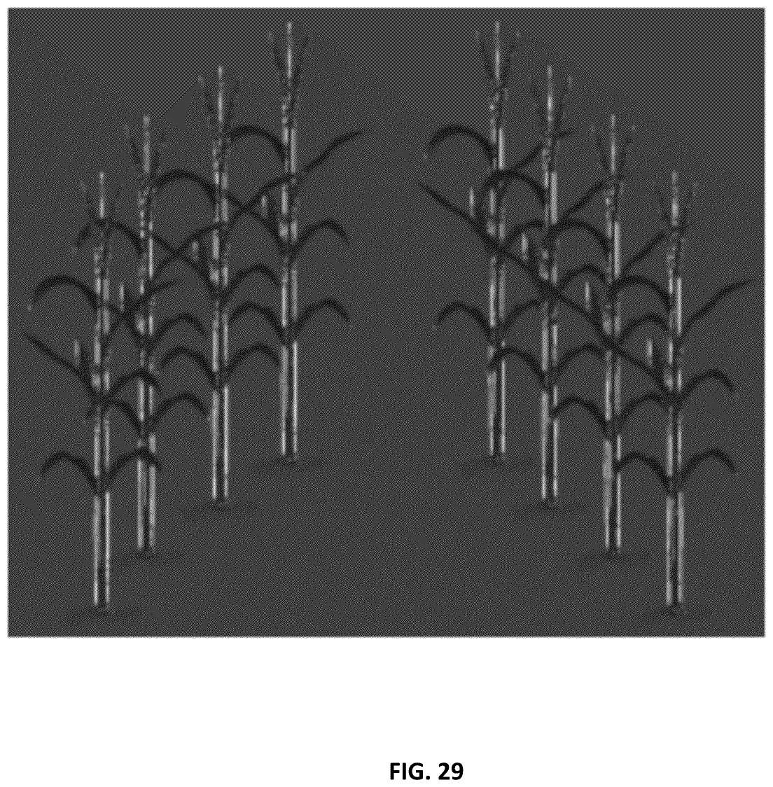

Applying the same Sobel operation to the region of interest as was previously discussed, then applying statistical methods to each column of the resultant image, and then making a binary mask centered on the peak intensities gives a resultant mask like the one shown in FIG. 31. Note that various statistical methods may be used. Without fully exhausting the list, some of these

could be taking the sum of all the elements of each column, taking the mean of each column, or some other method. Additionally, the centers of each of the high intensity regions may be found using a variety of methods, including but not limited to peak prominence, argrelextrema as supplied by scipy, gradient descent, or others.

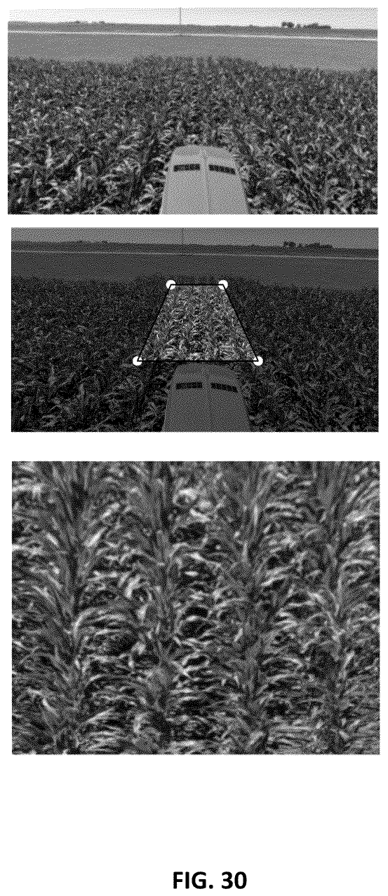

Finally, taking the resultant mask and unwarping it to put it back into camera space and then overlaying it on the original image, we may see that the 4 crop rows in the region of interest have been properly identified, as shown in FIG. 32.

### Benefits and Applications

To reiterate some of the benefits that are provided by picking out the vertical features in an image to find the centers of plants as opposed to other methods that may be used for segmentation, we may list them out as follows.

Note that this list is not all inclusive but does highlight the wide range of utility provided by this mythology.

Color independent: Since this method does not rely on color, the color of a plant does not affect the outcome. Thus, the method works just as well in healthy green corn as it does in harvest ready brown corn.

Plant type independent: Since the central stalk of a plant grows in a vertically for nearly all vegetation, this method works just as well for a variety of plant types. For example, it will work just as well for brown topped sorghum as it does for yellow sunflowers and just as well for wheat as it does in a vineyard. It would also work irrespective of plant height, thus would apply just as much for a tree farm as it would for soybeans.

Lighting independent: Since this method does not rely on color, the amount of ambient light or the change in color saturation as a result of sunny, cloudy, or rainy days does not impact the outcome of the process.

Growth stage independent: Since the central stalk of a plant grows in a vertical, sun-seeking, direction, the central stalk of a healthy plant will be vertical throughout the entirety of the plants lifecycle. Thus, this method works just as well at emergence as it would at harvest. Incidentally, it also works even if adjacent rows of crops are at different growth stages relative to one another.

Ignores leaves: Since this method masks out the non-vertical portions of a plant, leaves that would otherwise obstruct the image are intentionally ignored.

Finds centers: Since this method identifies vertical segments of plants and the vertical segment of a plant corresponds to the central stalk, this method will find the true center of a plant irrespective of more leaf growth on one side of the plant versus the other.

Camera placement independent: As shown, this method works just as well above and below a crop canopy. It also works just as well when the camera is oriented in the direction of travel of the vehicle or when the camera is mounted perpendicular to the direction of travel. It should be clear that this would also work for a fixed camera position (e.g. a camera mounted on a pole at the edge of a field or a camera on a grain silo over looking a field) or from an aerial shot (such as one from a drone or a satellite).

### Beyond Vertically

It should be clear that the process may easily be modified to identify horizontal or partially horizontal features in an image. Finding and highlighting fully horizontal features may be helpful to identify downed corn whilst finding partially downed corn (which is referred to as lodged corn) may be done by finding partially horizontal features in a given image. Being able to identify downed or lodged corn (or other crops/plants) may be useful from an agronomic standpoint as a way to identify overall crop health.

### Applications

Several applications have already been discussed but there are a few more that should be clear. Note that this list is also not exhaustive.

Identify the end of a row: For a camera mounted on an agricultural vehicle which exits the field, the vertical stalks would be replaced by some other feature. For example, one might exit the corn rows and see a stone wall, a field of grass, or recently harvest area (depending on geographic region and agricultural operation). In any case, the vertical features would no longer be present and that may be used to indicate to an operator or to the vehicle that the edge of the field/end of a row/end of unharvested area has been reached.

Identify the start of a row: Same as previous but inverted in that the vertically crop stalks would start to appear in the region of interest.

Agronomic: Getting a comparison of the amount of vertical vs lodged vs downed corn may be useful from an agronomic standpoint in determining the overall health of a field of crops.

Guidance: Finding the centers of plants may be used to properly generate a guidance line or guidance command that allows a vehicle to traverse between rows of crops whilst minimizing the risk of damage to plants. This would work just as well in row crops as in orchards or tree farms.

Semantic separation: Being able to find the stalks of plants and, given that most plants only have 1 stalk, would be useful in validating ML models or prior segmentation methods by ensuring that there is a bounding box or a segmentation for each plant and that neighboring plants have not been improperly identified as a single plant. It may also be used to seed segmentation models as some methods do better if the number of items to be segmented is known or if the center of an object has been approximated.

### C. Neighboring Rows

Generally, visual detection of row crops for the purpose of vehicle control is a well known problem with multiple product solutions available. Visually detecting the rows allows a machine to steer down a row crop without running over the plants. In addition, visual edge following has been used for various purposes including to collect hay into bales, follow tramlines, and locate the boundary between tilled and un-tilled ground.

However, specific challenges arise which significantly degrade the quality of row estimation and the resulting steering. First, rows of crops may disappear in the middle of the pass. The missing row may have been run over, the planter may have had a mechanical failure, or be due to insect pressure to name a few of various potential causes. Second, weeds may obscure the row. Depending on the method used to detect the row, a large area of weeds may obscure the rows by filling in the in-between space with green plants of approximately the same size. Third, water management issues may cause washouts in the field. Washouts may cause circular or curve shaped dead zones where no plants are present.

This provides a unique challenge because it requires finding a physically far away row to continue steering visually. Another challenge is the variability in row width. Row crops are frequently planted with 30, 21 or 15 inches of horizontal spacing between plants. In the tramline scenario the width left open for the follow on vehicles tires may be nearly any size. As plants grow, the remaining visible space between the rows decreases. More importantly, that space decreases irregularly. The morass of leaves growing in random directions will cause sudden deviations in the space between rows and shifts of the center of the remaining visible space. Existing solutions work in a limited growth stage of the crop which requires the plant to be small enough to leave plenty of open space. Current solutions may also require the user to select the planted row width.

What is needed are new and improved methods and systems which allow for a better estimate of the space between rows and/or automatically determine planted row width.

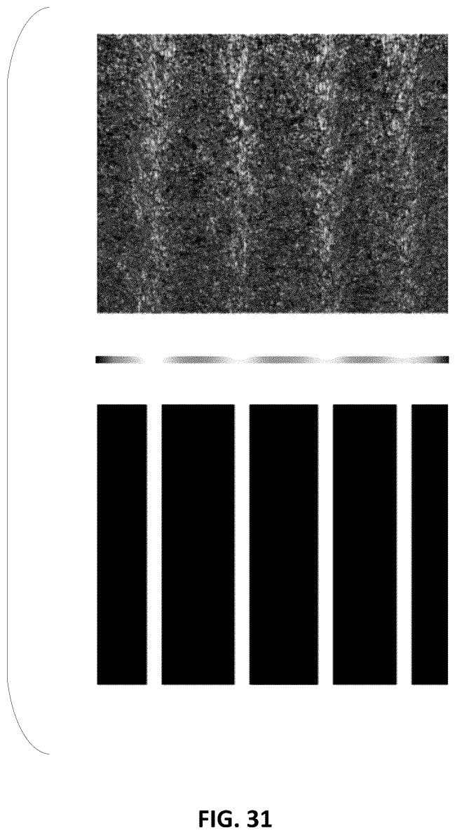

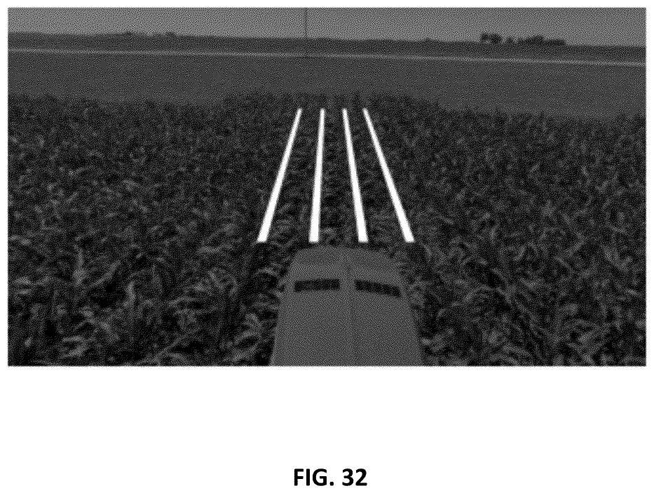

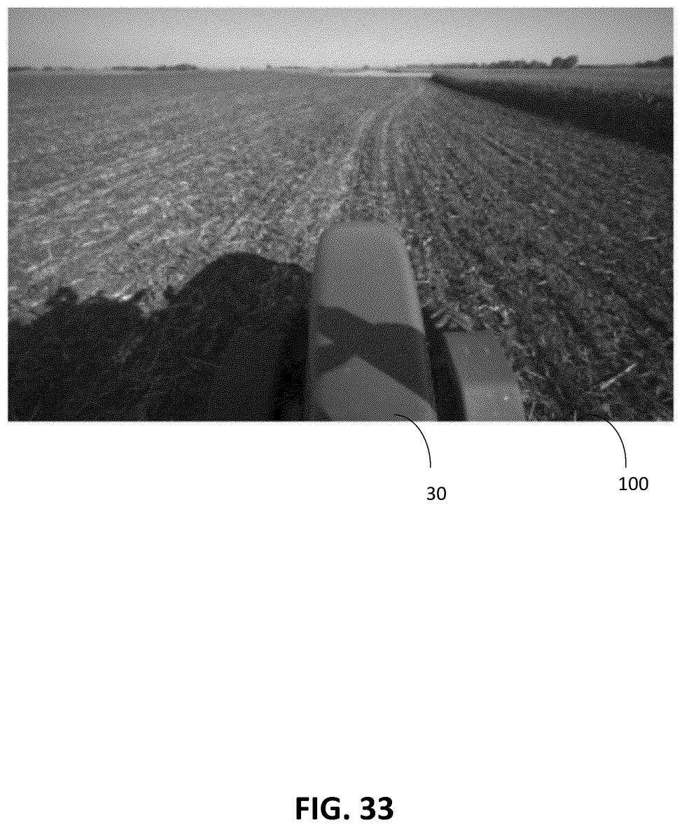

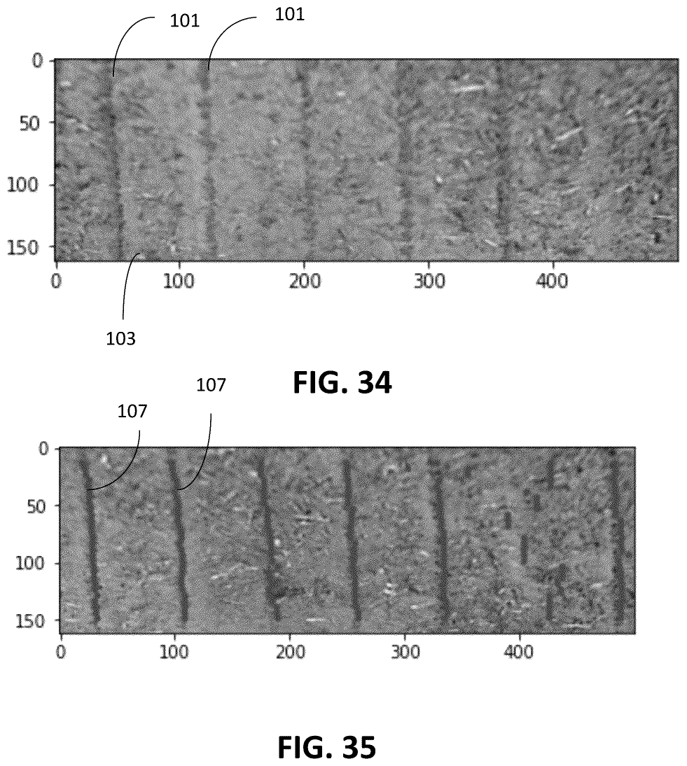

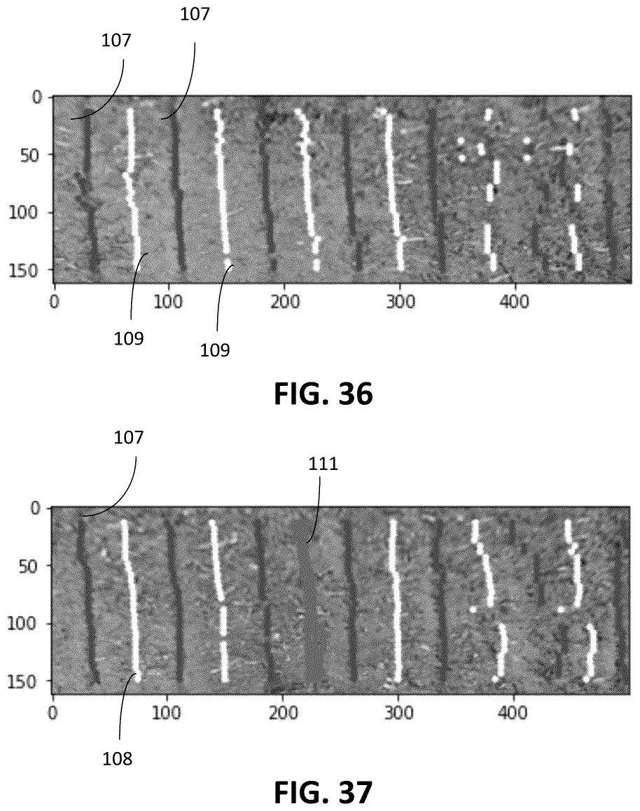

Generally, according to the present disclosure, after an image including a plurality of rows is acquired (as shown in FIG. 33), a perspective transform is performed to linearize the image (as shown in FIG. 34), then the method locates the positions of the plants apart from the spacing in between rows (as shown in FIG. 35), locates the center of the space between the rows (as shown in FIG. 36) estimates and/or updates the estimate of proper row spacing and then projects those centers back to the central open space chosen for guidance (as shown in FIG. 37). Thus, in this manner, crop rows, crop row spacing, or area between crop rows may be visually identified and then used for various purposes including establishing guidance lines, performing field operations, or otherwise.

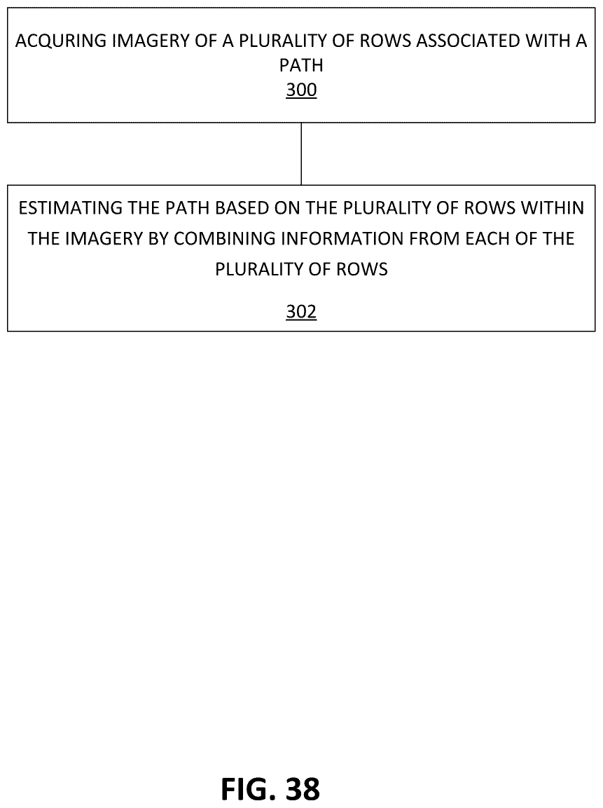

FIG. 38 illustrates an overview summarizing the methodology described in FIG. 33 to FIG. 37. In step 300, imagery is acquired which includes a plurality of rows associated with a path. In step 302, the path is estimated based on the plurality of rows within the imagery by combining information from each of the plurality of rows. Thus, one of the advantages of various implementations of the present disclosure is that a plurality of rows such as a row and neighboring rows are used in determining a path. By combining this information an improved path may be determined which may be used under a wide variety of crop conditions.

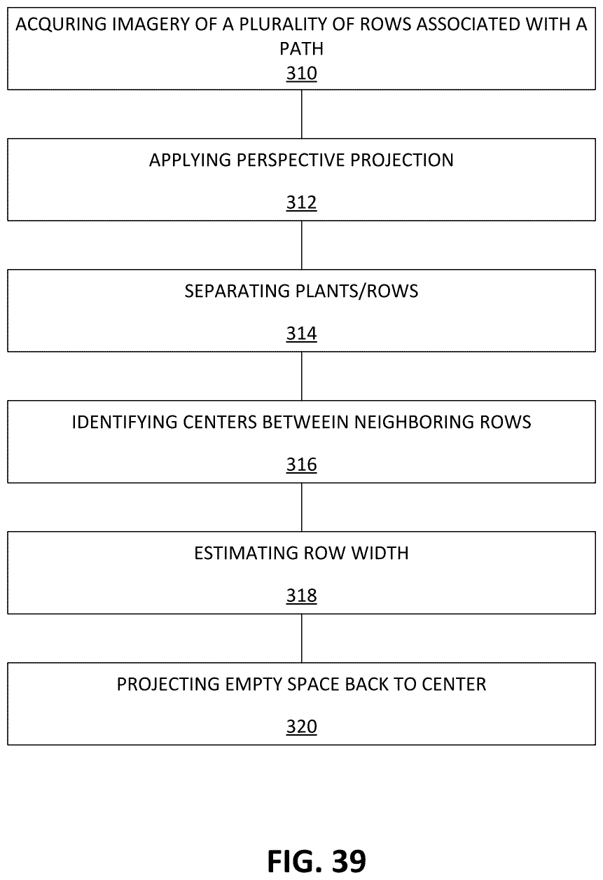

FIG. 39 also summarizes the methodology shown described in FIG. 33 to FIG. 38. In step 310, imagery is acquired of a plurality of rows associated with a path. The imagery may, for example, be acquired from a vehicle mounted camera. In step 312, a perspective projection is performed such as shown in FIG. 34. In step 314, there is separation of plants or rows. In step 316, centers between neighboring rows are identified. In step 318, row width is estimated. In step 320, empty space is projected back to center.

### Image Acquisition

As shown in FIG. 33, an image may be acquired in which a plurality of spaced apart crop rows are shown. In some applications, the image may be acquired from a vehicle mounted forward facing camera. FIG. 33 illustrates an example of an image acquired from a camera mounted on a vehicle 30. The image includes portions of a field 100 which includes a plurality of crop rows.

### Perspective Projection

In order to use the imagery acquired, the image from the vehicle mounted forward facing camera is projected to fix perspective. Natively, the pixel distance between rows decreases the further away the plants are from the camera, as seen in FIG. 33.

A perspective projection squares up the image so parallel rows also appear parallel within the image, as shown in FIG. 34. In FIG. 34, there are a plurality of crop rows 101 and there is empty space 103 between neighboring rows.

### Locate the Plants

After applying a perspective projection, the process may apply known methods to separate the plants from the empty space. This method may be of any type to include machine learning semantic separation, color difference or depth difference. In machine learning semantic separation, machine learning models such as deep learning models may be used to classify each pixel in an image into predefined categories and thus plants may be separated from empty space based on their sematic meaning. Where color difference is used, color-based segmentation may be used to separate plants from empty space based on color differences, for example to distinguish between green vegetation and barren soil. In depth difference, information about the distance of plants from the camera may be used to separate them from the background. It is to be further understood that methods may combine machine learning, semantic separation, color difference, and/or depth difference methodologies into a single process.

Another method which may be used to identify crop rows may rely upon column based identification of crop rows. According to that methodology, the image is converted into 2-dimesional space to provide a 2-dimensional image and the 2-dimensional image is trimmed to provide a subset of the image associated with a region of interest within the image. Note that the conversion may occur before the trimming or the trimming may occur before the conversion. Then, the subset of the image is sliced into at least one section. Next, each of the at least one section is statistically analyzed to provide a single dimensional summary. Then, the single dimensional summary may be processed for each section to identify peaks as crop row centers for each of the sections or valleys as empty space. The methodology may be performed in real-time while the agricultural vehicle traverses the field. Of course, other methodologies may be used.

FIG. 35 illustrates the identification of the plants 107 with the plants shown as red dots to distinguish from the green of plants. As shown in FIG. 35, plants 107 are marked in red. Note that not all plants are in neatly aligned rows, particularly in the rightmost three rows.

### Locating Centers

After the plants are identified, each row is paired with its neighbors to calculate the center between each pair. The leftmost line of dots, representing rows of plants, is iterated from top to bottom. Each point in that iteration is matched to a point in the right half of the pair. Finally, we calculate the geometric center between those two points. These geometric centers are stored separately based on which pair of red dots were used for calculation.

FIG. 36 illustrates the red dots 107 associated with the plants as well as white dots 109 showing the geometric centers between neighboring rows.

### Estimating Row Width

To estimate a row width an initial assumption may be used. This initial assumption may begin with a common row width, such as 30 inch rows or other common row width, a most recently used row width, or a row with supplied by an operator or machine. However, it is to be understood that one advantage of the present disclosure is the ability to determine row width even when it is unknown and so there is no requirement of knowing row width in advance, although an initial assumption is made and adjusted according to the process.

For example, the process may begin by assuming 30 inch rows as they are the most common. Next the process iterates through the leftmost set of white dots from top to bottom. For each white dot in the iteration we find the closest white dot for each of the other sets of white dots. The distance between the leftmost white dot and every other selected closest white dot is calculated and stored. This process continues until it reaches the bottom of the leftmost set of white dots.

Next, the process finds the closest factor of 30 inches for each previously stored distance. For example, a row 59 inches away will select 60 inches as its closest factor of 30. If each row is perfectly spaced and 30 inches is the true row spacing then each previously stored distance should be exactly a factor of 30. The difference between the closest factor of 30 for each distance to the previously stored distances is calculated and stored. The result is a total error from the assumed 30 inch rows. The process then applies any appropriate error reducing algorithm, such as gradient descent, to pick different assumed row spacings and re-run the just mentioned algorithm. The row spacing which produces the lowest overall error for all previously stored distances is chosen as the correct row width.

Finally, the output row width is filtered based on previous calculated row widths, starting with an assumed 30 inches. This stops temporary real field issues from adjusting the estimated row width.

### Project to Center

The set of white dots closest to the geometric center of the image is assumed to be the center row for steering at the start of the algorithm. This is the row, which if followed correctly, will place the wheels in the space between the rows of crops while traversing the field. After the start of algorithm the initially selected set of white dots is assumed to be the center even if the vehicle moves such that the selected set of white dots no longer are the closest to the geometric center of the image.

The chosen center set of white dots is iterated from top to bottom and the closest point to every other set of white dots is calculated. It is to be understood that in some implementations, this step and the previous may be combined for a single iteration. A distance is found between the current center white dot and the current other white dot. Next, the process finds the closest factor of the estimated row width to that distance. An error is calculated from that closest factor to the calculated distance. Finally, as shown in FIG. 37, the process places a magenta dot 111 at the position of the current center white dot plus the error just calculated. The result is each empty space between rows is projected back to the center guidance row. This increases the amount of data used to find the guidance row, improves curve fitting algorithms for those dots compared to just using the white dots and reduces the impact of temporary in field deviations such as those mentioned before. For example, the second from the right row in FIG. 35 is very poor due to poor plant emergence. The impact of this poor row is severely minimized by the projection of all rows to the center as is clear in FIG. 37.

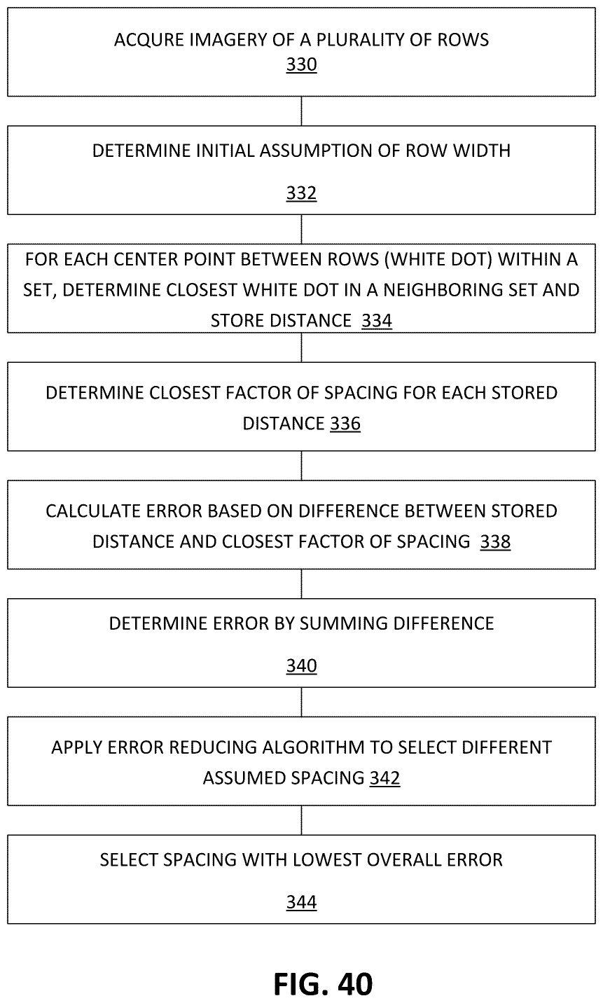

FIG. 40 illustrates one embodiment of the row width estimation. In step 330, imagery which includes a plurality of rows is acquired. In step 332, an initial assumption of row width is made. As previously described, one useful initial assumption is 30 inches as it is a common row width, however the initial assumption may be more or less, may be based on a user setting or equipment settings, or may be otherwise determined.

In step 334, for center point between rows (whit dot) within a set of such points, the closest point (e.g., white dot) within a neighboring set is determined and the distance is stored.

In step 336, the closest factor of spacing for each stored distance is determined.

In step 338, error is calculated based on difference between stored distance and the closest factor of spacing. In step 340, the error is determined by summing the difference. In step 342, an error reducing algorithm is applied to select a different assumed spacing. In step 344, spacing with the lowest overall error is selected.

### Uses

The methods shown and described herein may be used in any number of ways including, without limitation, row following or other guidance applications, weed or volunteer plant detection, or other types of applications. It should also be understood, that the methods are not necessarily limited to row crops but may be used in other types of applications including those previously mentioned.

### Row Following

This method improves the estimation of the space between rows an operator wishes to follow. Based on the determination of row location, guidance lines including geodetic guidance lines may be generated. The ability to obtain better guidance lines allows for row following in a manner which reduces potential for crop damage such as by keeping wheels of a vehicle and/or implement as centered as possible between rows.

### Weed or Volunteer Plant Detection

Although in the example shown, the emphasis was on identifying plants within the rows, the method may be inverted to find the plants, red dots, which are substantially out of alignment with the rest. This method allows us to identify those plants as undesirable weeds or volunteer plants. Once these are identified, appropriate activations may be taken such as through cultivation operations, sprayer operations, or other operations to remove the weed or volunteer plants. Thus, the row alignment estimation portion of the method may be used to mark volunteer plants or weeds based on their misalignment with the row. After out of alignment plants are identified, the out of alignment plants may be characterized such as volunteer plants or weeds, or otherwise. It is contemplated, that this information may be used in subsequent operations including cultivating, spraying, tillage, or other types of operations.

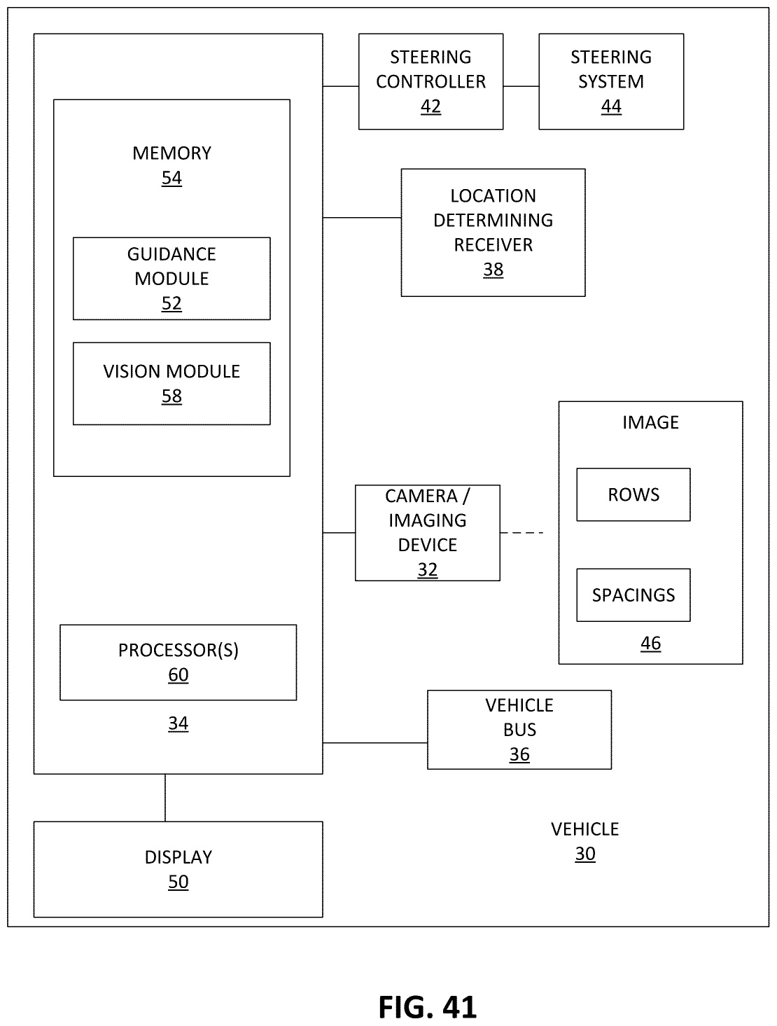

FIG. 41 illustrates one example of a system. As shown in FIG. 41, a vehicle 30 is configured to include a control system 34. The control system 34 includes a guidance module 52 which may be used to generate or access guidance lines and control a steering controller 42 which may in turn control a steering system 44. A location determining receiver 38 such as a GPS receiver may be used by the guidance module 52 to determine vehicle position or associated positions.

A vision module 58 is also shown which may be implemented as a collection of software instructions stored on a machine readable memory 54 which may be executed on one or more processors 60 of the control system. The vision module 58 may be self-contained with its own processors and memory or may share resources with other aspects of the control system 34. A display 50 may be operatively connected to the control system 34 and may display imagery such as an image 46 acquired with a camera or other imaging device 32. The display 50 may be used for other purposes as well including to show maps, guidance lines, or other information of interest to an operator. The image 46 may include a representation of multiple rows and spacings in between the rows such as the image shown in FIG. 33.

A vehicle bus 36 may also be operatively connected to the control system. Information about equipment being used or control of agricultural vehicles, control of agricultural implements and associated operations, access to vehicle or implement settings, production data, or other information may be communicated through the vehicle bus. In some embodiments, steering may be performed through the vehicle bus 36.

Thus, the system may be used for autonomous vehicles, semi-autonomous vehicles, or operator driven vehicles where guidance lines are used either directly by the vehicle or to generate guidance lines which may be displayed to the operator, to determine row spacing, or to identify weeds or volunteer plants.

In some aspects shown and described, training data may be obtained. Where the methods shown and described generate data, this data may be used as training data to train machine learning algorithms such as, but not limited to, neural networks. Any number of neural networks may be used. Training a neural net may allow for faster computational time and/or reduced computational resources in estimating the path based on the plurality of rows within the imagery by combining information from each of the plurality of rows. Similarly, training of a neural net or other machine learning algorithm may allow for faster computational time and/or reduced computational resources in determining true crop row spacing.

Although various embodiments have been shown in the context of agricultural application such as row crops including corn and soybeans, it is contemplated that the methods and systems shown and described may be used in other applications including: other types of agricultural applications including where windrows or tramlines are used; applications such as in forestry, orchards, vineyards, and horticulture; land management applications such as landscaping and maintenance, snow removal and the like; warehouse management; and other types of applications.

The invention is not to be limited to the particular embodiments described herein. In particular, the invention contemplates numerous variations in its application, type of features, sets of features, and other variations. It is to be understood that the imaging device may be mounted on vehicles, may be used for agricultural uses including row crops, may be used with respect to a specific region of interest as determined by the user or as automatically calibration, may be used in warped perspective space, may be used in camera space, may be used in navigation space, may be used in warped perspective space which is then unwarped into camera space, is limited to lines, may be used within shapes that include a color and/or size. Where lines are used, the lines may be straight lines, non-straight lines/curves, polynomials, sums of sines/cosines, sums of Gaussian function.

### D. Regression on Visual Plants

Another aspect relates to regression on visual plants. As cameras make their way on to vehicles, the amount of data the is processed and stored rapidly increases. A singular feature in an image, even when it is relatively small may still be comprised of hundreds, thousands, or hundreds of thousands of pixels. Storing the locations of all of those pixels for a singular item may make iterating over individual features computationally expensive.

Thus any method that may be used to reduce the amount of storage space needed to retain pertinent information about an environment without loss of critical data is beneficial. This is one of the reasons that openCV, when utilized in python, sometimes allows one to iterate over groups of features. For example, if one were to apply Canny edge detection to an image, python will store all of the edges and allow one to iterate over the list of edges. While this is useful from a coding standpoint, wherein a singular microfeature includes multiple sub-features, there is no way to automatically store the macro feature in a computationally inexpensive manner. Additionally, if there are breaks in a feature (e.g., a crop row which should be seen as a singular item but may be split into many individual plants if semantic segmentation methods are used) or if one wishes to group items differently than is automatically chosen, one is unable to utilize the space saving benefits of iterating over a feature.

Therefore, what is needed are new and improved methods and systems which allow for storing features or series of features within an image while requiring less data storage.

Given any series of points in an image, such as those show in FIG. 1a, such that those points are correlated to some feature, let the location of the feature to which they correspond be stored in an alternative manner than merely saving out the pixels for the feature or the points.

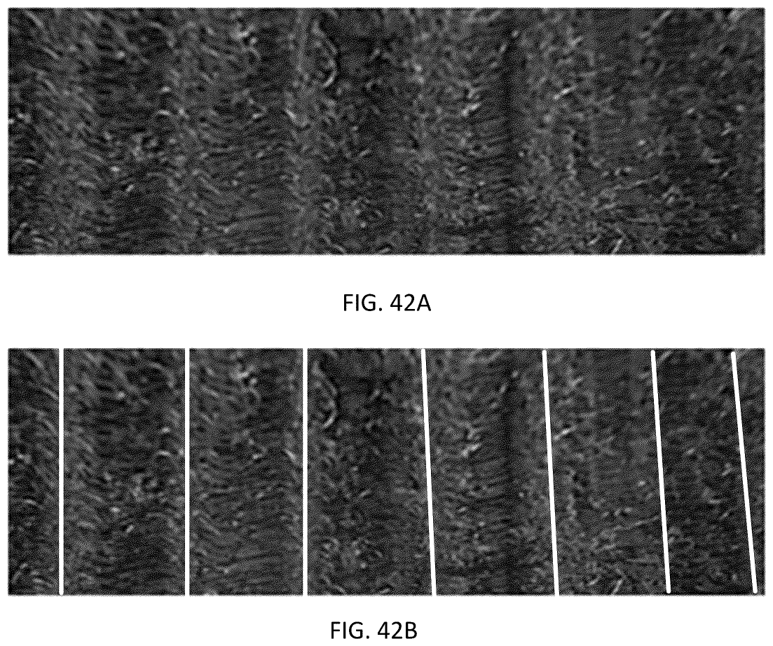

For example, the points in FIG. 42A were generated such that they correspond to the center of a row of corn plants. Instead of storing the pixel locations for each of the red dots, which would constitute multiple points per row (in this case, 5 points for most of the rows), one may instead store the coefficients of a straight line, whose equation may be written as y=mx+b, thereby reducing the amount of storage space from 5 elements to 2 (i.e. just the slope and y-intercept of each line). In this instance, instead of storing 32 individual points, one may instead store 2 parameters for each of the 7 crop rows (i.e., 14 parameters). Furthermore, if each circle is not a singular pixel but is instead comprised of multiple pixels (in this example, each circle has a radius of 5 pixels and a total covered area of about 80 pixels), then the savings are even more drastic as instead of 14 parameters, one would have had to store 2560 pixels. Additionally, if there were more points per crop row (e.g., 10, 20, or more) then the savings would, clearly, compound.

While the points shown in FIG. 42A, were automatically generated using the Column Based Identification of Crop Rows process, they may have been generated using any other automatic labeling process, such as the Center of Plant finder, or they may have been selected by hand.

An added benefit of storing the data in this manner is that the entirety of a crop row is identified. This allows one to interpolate along a smoother line when querying a point between two of the originally identified points as opposed to having what would be a noisier interpolation if only the two closest points were used.

Similarly, in the event that plants or features are missing, since the best fit line is continuous, one may interpolate the data along each row in equally spaced and uniform manner. This would be particularly useful as the step-size/distance between points may be selected based on the application. For example, if one were trying to combine information from each row in such a way as to make a central guidance line, and that guidance line needed to be set as a series of way points, then the continuous nature of the best fit line would allow the spacing between way points may be set to any value/distance.

If a controller were designed to follow a singular row of crops and in the case that each point corresponded to an individual plant as found using some process (e.g. semantic segmentation), then the spacing between points when a plant is missing might exceed the allowable limit for a good series of way-points. For example, corn plants are generally spaced every 6 inches but, if one or two plants were missing, then the spacing would jump to 12 or 18 inches which may exceed the distance that the central controller expects the way points to be spaced at. By fitting a continuous curve or a line the series of plants/features, we may upsample the original points into perfectly spaced way-points, thereby giving the centralized guidance controller the best possible data for it to steer along. If, on the other hand, the guidance controller would get overwhelmed if it were provided a way-point every 6 inches and would, instead, prefer a way point every 3 feet, then the best fit line may easily be downsampled to the appropriate spacing whilst still making full use of the more closely spaced original data points.

This process may be extended to tracking simple shapes (e.g., circles, squares, hexagons, etc.) in an image instead of having to store all of the pixel data for each shape, one may choose to merely store the shape, size of the shape, and its midpoint. This will be discussed more fully later herein.

### Applications

While these applications are not the only possible applications for this invention, they do serve to show the utility of it in various environments.

### On the Road

In the United States, we have many different types of road signs and these are broken out into several standard shapes and colors. For example, we know that a red sign, regardless of the shape indicates stop or prohibited whereas a yellow sign corresponds to a general warning, a green sign indicated that movements are allowed or gives guidance for directions (e.g. highway exits) and a brown sign is used to indicate public recreation or scenic guidance (e.g. a lookout point or a state park).

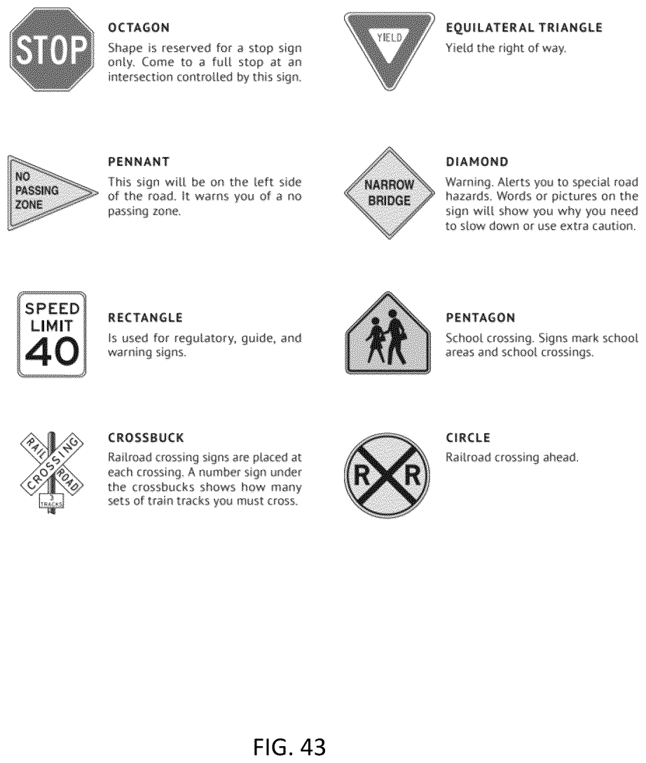

The shape of a sign is also indicative of specific information regardless of a sign's color, FIG. 43 shows the standard shapes for road signs in the US and their respective meanings.

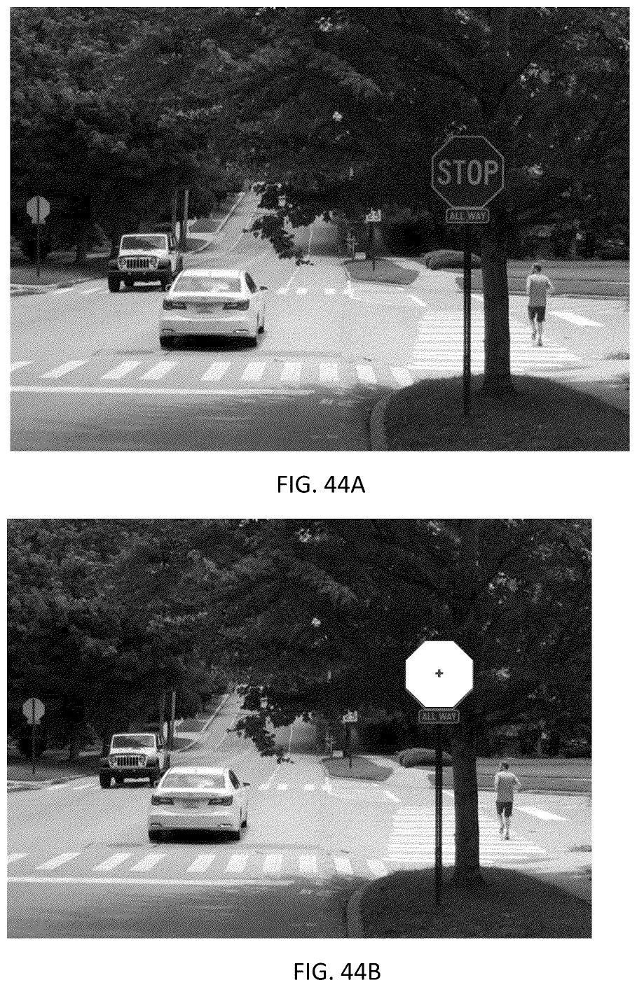

If a camera were mounted onto a moving vehicle on a road in the US, it would be beneficial to not have to store the pixel data for every pixel containing a portion of a given road sign. If instead, just the coordinates of the middle of the sign, the size of the sign, and its color may be stored, then the savings would be drastic and all of the pertained information would be retained. FIGS. 44A, 44B show how this would work.

For this example, the original image has a size of 425×330 which is 143, 550 pixels. The stop-sign comprises roughly 10 percent of the image which would correspond to about 14, 350 pixels. Using this method, instead of storing an array of that size, we may instead store only 3 key parameters (center, shape, and color) without loss of any pertinent information. It should be clear that this would provide even more benefits in cluttered environments where multiple road signs may be seen at the same time.

### In a Field

Shaped summarizing. Similarly to how one may identify and store the locations of relevant features in an urban road environment, the same may be done for obstacles or features in an agricultural setting. For example, fields often run up against the side of roads and there are often telephone poles or signage alongside those roads. Thus, the location and size of the telephone poles may be stored instead of the vast number of pixels encompassing the pole. Other relevant features that may be summarized in this way include but are not limited to fencing, walls, buildings, roads, trees, boulders, or other large and simply shaped features.

Knowing and storing the locations of various obstacles or features in a field may be useful if those features then needed to be removed (e.g., a downed tree) or if those features may be used to augment positioning data by being used as some sort of a datum (e.g., a road intersection or a building with a known location).

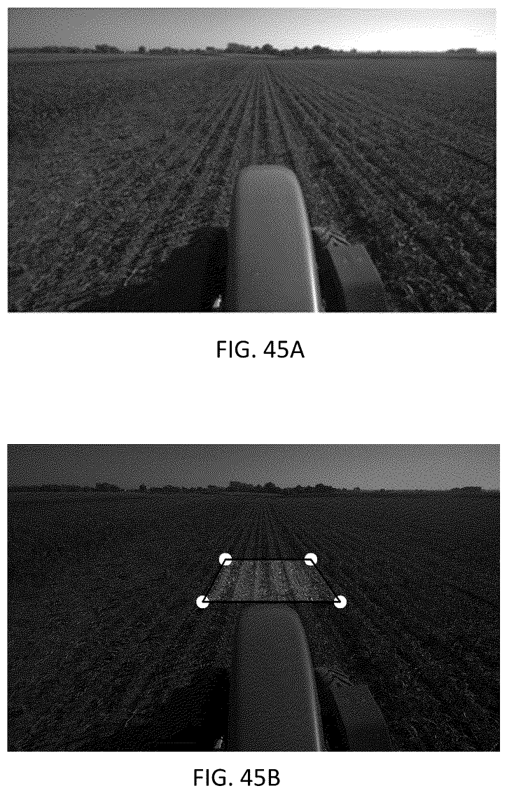

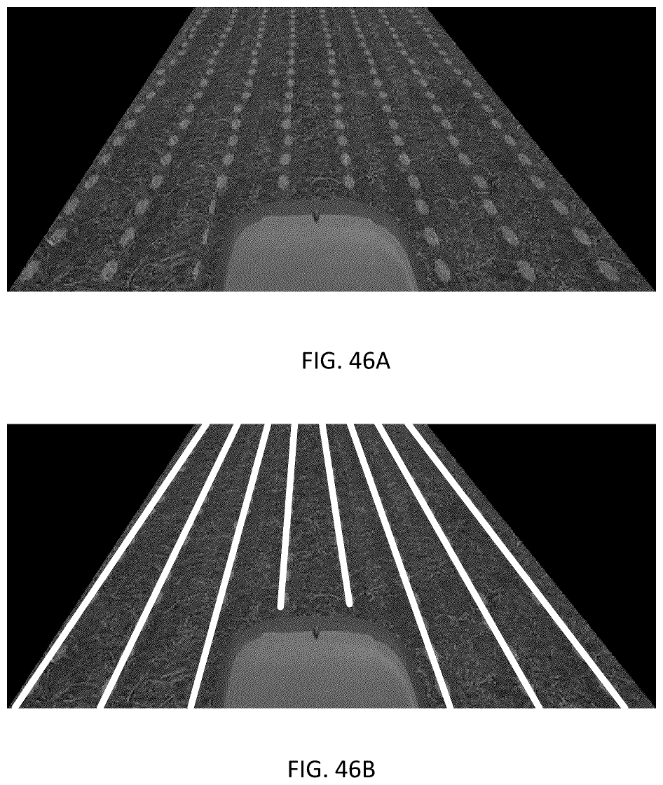

Guidance and row identification. Moving from feature identification and summarizing to guidance applications, if one mounts a camera onto an agricultural vehicle, where the camera is in line with the direction of motion of the vehicle, and then a region of interest is selected from the overall image (as shown in FIGS. 45A, 45B) then the crop rows in that region may be identified using various methods. If we use the same method as was used to find the rows in FIG. 42A, then we may get an image like the one shown in FIG. 46A.

Note that this image may have a perspective warp applied to the region of interest as was done for FIG. 42A to approximate a bird's eye view of the rows and ensure that straight rows are all parallel. Alternatively, the region of interest may be kept in camera space where the lensing effect of the camera causes straight parallel rows to appear to converge toward a vanishing point. This method works equally well in both scenarios and the only difference will be the equations of the lines generated as the bit fit for any given series of points for a given row of crops. Thus, even though both FIG. 42B and FIG. 46B depict best fit lines for straight and parallel crop rows, the equations for those lines would be different.

It should be clear that since this method works both in perspective space and in camera space, that it would work just as well if the points were first transformed into navigation space. Incidentally, this same method may be utilized as a way to down-sample or up-sample a series of waypoints that were calculated in perspective space before converting them into camera space, navigation space, or any other coordinate system.

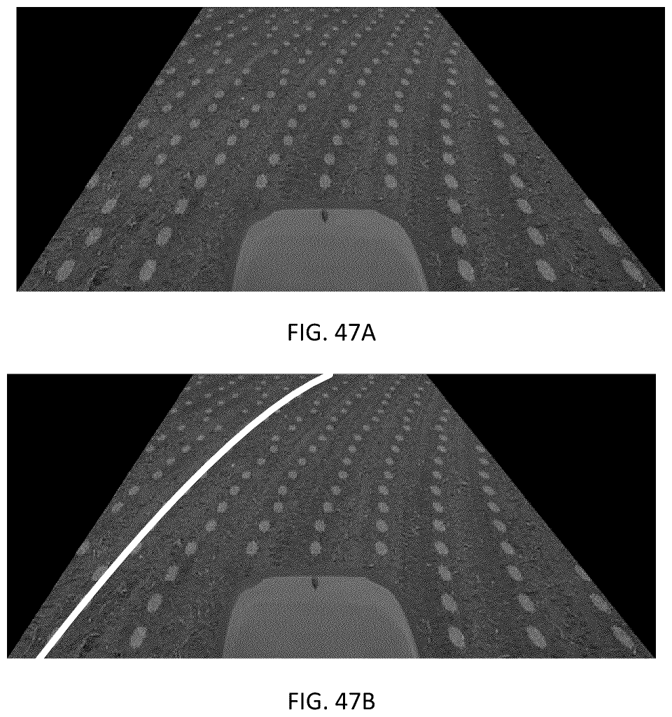

It should also be clear that this method is not restricted to straight lines but may be used for any type of curve. FIGS. 47A and 47B show a series of corn rows that are curving to the right and the best fit line for one of those curves. While a best fit line may be shown for each of the 12 visible rows, only one is depicted for the sake of clarity. This one line shows that the process is viable and that missing plants may still be compensated for even on significant curves.

For the example best fit line shown in FIG. 47B, a second order polynomial was used but any order of polynomial or any other method to fit a curve (e.g., sum of sinusoidals, gaussians, etc.) may have been utilized. An additional benefit of fitting a curve to the original data as opposed to using the points directly is that we may place conditions on the curve fit that align with foreknowledge of the system. For example, if we know the maximum curvature that a given agricultural vehicle may achieve, then we know that the crop rows cannot have been planted in a pattern that is tighter than that curvature.

Thus, if there is a significant amount of weed pressure or if plants are missing then we may limit the curve fits that are attempted to solely use reasonable curvature values thereby ensuring that each lane is properly identified and that points from adjacent rows are not accidentally convolved.

Similarly, we may place restrictions on the quality of the line fit that is utilized by using any of a myriad of traditional statistical methods. For example, we may choose to set a limit on the RMS error between the proposed curve fit and the original points found for the line. In the event that there was too much noise in the original data (e.g., due to weeds, adverse lighting conditions, or missing plants) then the RMS condition may be used to reject a curve fit and the curve used on a previous frame may be used instead or the frame may be flagged for further review.

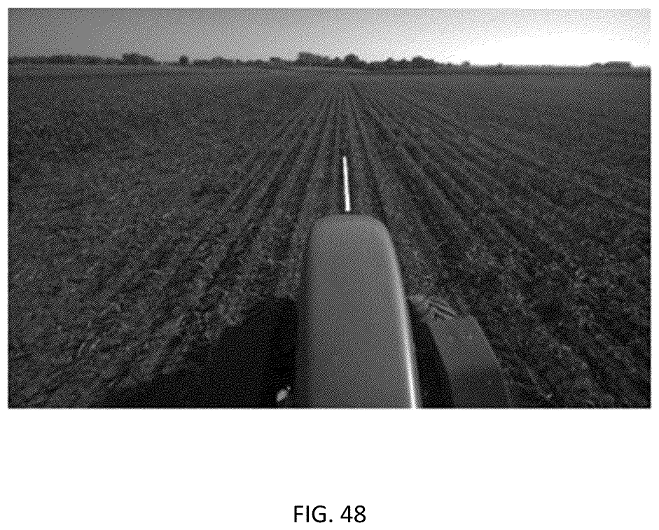

Once we have a best fit line for at least one of the crop rows, we may use this information to generate a guidance line between rows, as shown in FIG. 48. This may be done using a variety of methods to shift or combine the row lines to generate the guidance line. For example, one may average all of the rows and steer along the center.

### Advantages of This Method

While several advantages are provided by using this method and many of those have been discussed, this is a short summary of some of those previously mentioned.

Less data to store: Storing just a few key parameters for a best fit line (e.g., coefficients for a polynomial) instead of many pixels for each feature provides significant savings in storage and facilitates post processing the data, if needed.

Highlights the full feature: Instead of just picking out individual plants, the whole crop row may be highlighted. This is useful for steering and for object segmentation.

Compensates for missing plants: In the case that plants are missing or not visible, this method allows for the whole row to still be considered a singular feature instead of being broken into multiple sub segments.

Smooths out noise: If there are plants that have popped up between rows (e.g., volunteer corn or weeds) that may throw off a color segmentation methodology or a neural net's attempt to label plants or even a whole row, this method allows for those flyer points to be ignored or compensated for.

Allows for use of foreknowledge: Additional information that is known about the system may be applied to the curve fit to further improve the line fit and to ensure that any guidance line generated as a result of the points is reasonable. This may be information about maximum curvature, plant spacing, row spacing, original guidance line used when the crops were planted, just to name a few examples.

In Camera Space: If a guidance line is generated in perceptive mode or in camera space, the best fit line which utilizes the points found may be used as a starting approximation for the locations of the points in following frames. This would be beneficial in that noisy frames or invalid data may be filtered out or ignored.

In Navigation Coordinates: If a guidance line is generated in navigation coordinates, the locations of set way-points or points used to generate a best fit line will stay constant irrespective of the motion of the vehicle and the corresponding changes in camera view. Thus, points that have been found need not be recalculated every time and a greater history of points may be used thereby allowing for an even better curve fit. In fact, given that the point are in navigation space, points from different frames may be fitted at the same time, thereby allowing for much greater accuracy when determining the location of a crop or a lane between rows. The conversion of points from perspective or camera space in the navigation space may be performed in any number of ways.

### E. Conclusion

The foregoing disclosure provides illustration and description but is not intended to be exhaustive or to limit the implementations to the precise form disclosed. Modifications may be made in light of the above disclosure or may be acquired from practice of the implementations. As used herein, the term “component” or “module” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware may be used to implement the systems and/or methods based on the description herein. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more”. Further, as used herein, the article “the” is intended to include one or more items referenced in connection with the article “the” and may be used interchangeably with “the one or more”. Furthermore, as used herein, the term “set” is intended to include one or more items (e.g., related items, unrelated items, a combination of related and unrelated items, and/or the like), and may be used interchangeably with “one or more”. Where only one item is intended, the phrase “only one” or similar language is used. Also, as used herein, the terms “has”, “have”, “having”, or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

Although different embodiments or examples are provided it is to be understood that elements of different embodiments may be combined.

Where processes include a set of steps it is to be understood that the steps do not necessarily need to be performed in the order provided unless context expressly requires it in order for the process to be operational.

Where terms such as “horizontally” or “vertically” are used, it is to be understood that such terms are being used as a manner of convenience and it should be understood that any orientation may be used.

In some instances, the term “features” includes features such as peaks or troughs. In some embodiments, it is contemplated that instead of identifying plant colors one may identify ground color.

Although different embodiments or examples are provided it is to be understood that elements of different embodiments may be combined.

Where processes include a set of steps it is to be understood that the steps do not necessarily need to be performed in the order provided unless context expressly requires it in order for the process to be operational.

Where specific colors have been used within images to assist in visually understanding the imagery shown, it is to be understood that other colors may be used instead or alternative methods may be used to allow for visually identifying different aspects of an image.

It is also to be understood that various features from different embodiments may be combined. For example, a system may include a processor configured to perform different methods of identifying crop rows and may select the best method for a particular situation or may provide for identifying crop rows using multiple methods and selecting the best result, or combine results from different methods to provide a better result. For example, a system may be configured to apply a column based identification approach, a find plant center approach, and a neighboring rows approach even if not all approaches are used for each image. It is to be further understood that various features may be described within particular embodiments, but that certain features or methods may be function independently with broader application than to the specific embodiments described. For example, although the regression methodology shown and described is useful in reducing memory and storage requirements in the context of agricultural, including storing crop row information, this method may be applied in any number of different contexts or environments including those not associated with agriculture.

The disclosure is not to be limited to the particular aspects described herein. In particular, the disclosure contemplates numerous variations. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of aspects, processes or methods of the disclosure. It is understood that any other modifications, substitutions, and/or additions may be made, which are within the intended spirit and scope of the disclosure.

What is claimed is:

1. A method for visually identifying crop rows comprising:
acquiring imagery from at least one imaging device operatively connected to an agricultural vehicle while the agricultural vehicle is traversing a field, the imagery including a plurality of plants arranged in rows;
processing the imagery at a computing device to preserve spatial information along a first dimension while reducing data complexity along a second dimension to generate processed data; and
analyzing the processed data to identify locations of the rows within the field.

2. The method of claim 1 wherein the processing the imagery comprises:
dividing the imagery into multiple sections along a direction of travel of the agricultural vehicle; and
for each section, performing statistical analysis to generate a one-dimensional intensity profile.

3. The method of claim 1 wherein the processing the imagery comprises:
applying an edge detection operation to identify predominantly vertical features within the imagery; and
filtering out predominantly horizontal features to isolate plant stalks.

4. The method of claim 1 wherein the analyzing the processed data comprises identifying peaks within the processed data, wherein the peaks correspond to centers of the rows or centers of space between rows.

5. The method of claim 1 further comprising:
identifying spatial relationships between neighboring rows; and
using the spatial relationships to validate row identification.

6. The method of claim 5 further comprising dynamically determining row spacing based on the spatial relationships between neighboring rows.

7. The method of claim 1 further comprising:
generating a mathematical representation of the identified rows using continuous functions; and
using the mathematical representation to interpolate row locations between identified points.

8. The method of claim 1 wherein the imagery comprises a region of interest ahead of the agricultural vehicle, and further comprising generating steering commands based on the identified row locations within the region of interest.

9. The method of claim 1 further comprising:
identifying plants that deviate from the identified row locations; and
characterizing the deviating plants as one of weeds or volunteer plants.

10. The method of claim 1 wherein the computing device is onboard the agricultural vehicle.

11. The method of claim 1 further comprising generating a guidance line based on the locations of the rows within the field.

12. The method of claim 11 wherein the guidance line is curved.

13. The method of claim 11 further comprising generating steering commands for the agricultural vehicle based on the guidance line.

14. The method of claim 13 further comprising autonomously or semi-autonomously steering the agricultural vehicle using the steering commands.

15. A system for identifying crop rows in real-time comprising:
at least one camera;
one or more processors configured to:
acquire an image of a crop field from the at least one camera, the image including a portion of at least one crop row;
process the image to preserve spatial information along a first dimension while reducing data complexity along a second dimension to generate processed data;
analyze the processed data to identify locations of the at least one crop row.

16. The system of claim 15 further comprising a location determination receiver operatively connected to the one or more processors to provide a location.

17. The system of claim 15 wherein the one or more processors is further configured to analyze the processed data by identifying peaks within the processed data, wherein the peaks correspond to centers of the rows.

18. The system of claim 15 wherein the one or more processors is further configured to identify spatial relationships between neighboring rows, and use the spatial relationships to validate row identification.

19. The system of claim 18 wherein the sys one or more processors are further configured to dynamically determine row spacing based on the spatial relationships between neighboring rows.

20. The system of claim 15 wherein the one or more processors is further configured to generate a mathematical representation of the identified rows using continuous functions.
